(19) United States
(12) Patent Application Publication
(10) Pub. No.: US 2016/0241574 A1
(43) Pub. Date: Aug. 18, 2016

(54) SYSTEMS AND METHODS FOR DETERMINING TRUSTWORTHINESS OF THE SIGNALING AND DATA EXCHANGE BETWEEN NETWORK SYSTEMS

(71) Applicant: Taasera, Inc., Erie, PA (US)

(72) Inventors: Srinivas KUMAR, Cupertino, CA (US); Shashank Jaywant PANDHARE, Pune (IN)

(73) Assignee: Taasera, Inc., Erie, PA (US)

(21) Appl. No.: 14/623,288

(22) Filed: Feb. 16, 2015

(51) Int. Cl. H04L 29/06

(52) U.S. Cl. CPC H04L 63/1416; H04L 63/1425

(57) ABSTRACT

A method of determining real-time operational integrity of an application or service operating on a computing device, the method including inspecting network traffic sent or received by the application or the service operating on the computing device, determining in real-time, by a network analyzer of an endpoint trust agent on the computing device, signaling integrity and data exchange of the application or the service based on the inspecting of the network traffic to assess trustworthiness of the signaling, and data exchange, and determining, by the network analyzer, that the application or the service is malicious based on the determined trustworthiness of the signaling and data exchange.

### APPENDIX

A computer program listing appendix is included with this specification and provides one example of threat grammar and will be referenced as Appendix 1.

### BACKGROUND

### Field of the Disclosure

The present disclosure relates to the field of network and computing systems security, and more particularly to a method of determining the operational integrity of an application or system operating on a computing device.

Traditional security technologies including detection and defense technologies such as legacy and currently available anti-virus software, network firewalls, and intrusion detection/prevention systems depend on signatures to monitor threats and attacks. Increasingly sophisticated emerging threats and attacks are developing techniques for evading these traditional detection and defense technologies. For example, a threat may modify its signature in an attempt to remain undetected by traditional technologies. Other threats may detect the presence of traditional detection and defense techniques and employ methods tailored to avoid detection.

Traditional detection and defense techniques tend to be based on a hard edge and soft core architecture. Some examples of techniques employed at the hard edge are security appliances such as network firewalls and intrusion detection/prevention systems. Examples of techniques employed at the soft core are antivirus and network based integrity measurement and verification services that scan and audit business critical systems, services, and high value data silos. When the hard edge is breached, however, these defensive methods are largely ineffective in protecting vulnerable or compromised systems, do not provide any level of assurance of the runtime operational integrity of the soft core, and do not prevent the exfiltration of information from compromised systems, or exfiltration of information due to rogue insiders within the enterprise.

Typically, advanced threats have a life cycle where the threat is delivered, where the threat evades detection, and where the threat persists and takes hold. During each of these stages, signals to and from internal and external actors are transmitted and received from the portion of the advanced threat that has been delivered into an enterprise. Although enterprises are aware of at least some of these threats, the traditional defense and detection techniques that are employed tend to use pattern matching or other signature matching algorithms to detect intrusions. Other traditional techniques employ reputation-based lists of network addresses or domains in an effort to detect threats.

The authors of malware and other threats are aware of traditional defense and detection techniques and have adapted their threats to evade and avoid such defenses. For example, advanced threats may use multiple networks to extract information from an enterprise, or use seemingly benign data flows to camouflage the extraction of information. Other advanced threats may detect attempts to detect and decipher activity by detecting the presence of sandboxing or virtual machine execution. In response, these advanced threats may use delayed or conditional unpacking of code, content obfuscation, adaptive signaling, dynamic domains, IP and domain fluxing, and other techniques to evade traditional detection and defense techniques.

One example is when advanced threats leverage the syntax of standards-based protocols, like Hypertext Transmission Protocol (HTTP), to transmit information. Traditional defense and detection techniques do not examine the information exchanged over these standards-based protocols because any violations in the protocol are addressed by the application, not the transport or networking infrastructure. This allows advanced threats to use standards-based channels to transmit signals for command and control purposes and information extracted from data silos without being detected through conventional techniques. Other times, advanced threats will conform to the appropriate standard, but will employ encoded, encrypted, or otherwise obfuscated malicious communications in an effort to evade detection. In still other situations, advanced threats will conform to applicable standards and indicate that the transported content is of one type, but in fact transport content of another type. For example, the advanced threat may declare that the information being transferred is an image file when the information is in fact an executable binary.

A need therefore for a solution that offers a way to more reliably determine the operational integrity of an application or service operating on a computing device.

### SUMMARY

These and other exemplary features and advantages of particular embodiments of the methods for determining real-time operational integrity of an application or service operating on a computing device will now be described by way of exemplary embodiments to which they are not limited.

A method of determining real-time operational integrity of an application or service operating on a computing device including inspecting network traffic sent or received by the application or the service operating on the computing device; determining in real-time signaling integrity of the application or the service based on the inspecting of the network traffic to assess trustworthiness of the signaling; and determining that the application or the service is malicious based on the determined trustworthiness of the signaling.

17. A method of determining real-time operational integrity of an application or service operating on a computing device including inspecting network traffic sent or received by the application or the service operating on the computing device; determining in real-time integrity of a data exchange of the application or the service based on the inspecting of the network traffic to assess trustworthiness of the data exchange; and determining that the application or the service is malicious based on the determined trustworthiness of the data exchange.

### BRIEF DESCRIPTION OF THE DRAWINGS

The scope of the present disclosure is best understood from the following detailed description of exemplary embodiments when read in conjunction with the accompanying drawings. Included in the drawings are the following figures:

FIG. 1 illustrates an environment in which a system in accordance with one exemplary embodiment is deployed;

FIG. 2 illustrates details of a computing device with an endpoint trust agent in accordance with one exemplary embodiment;

FIG. 3 illustrates details of the internal systems in accordance with an exemplary embodiment;

FIG. 4 illustrates additional details of a computing device in accordance with an exemplary embodiment;

FIG. 5 illustrates an exemplary method the components of FIG. 4 may interact to determine the trustworthiness of signaling and data exchange between network systems;

FIG. 6 illustrates packet payloads in accordance with one exemplary embodiment;

FIG. 7 illustrates a method in accordance with an exemplary embodiment;

FIG. 8 illustrates a method of determining the relevance of an alert in accordance with one exemplary embodiment;

FIG. 9 illustrates threat alerts in accordance with exemplary embodiments;

FIG. 10 illustrates runtime dashboards in accordance with one exemplary embodiment;

FIG. 11 illustrates runtime dashboards in accordance with an exemplary embodiment;

FIG. 12 illustrates a method in accordance with an exemplary embodiment;

FIG. 13 illustrates a method in accordance with one exemplary embodiment; and

FIG. 14 is a diagram of an exemplary computer system in which embodiments of the method of determining trustworthiness of signaling and data exchange between network systems can be implemented.

### DETAILED DESCRIPTION

Exemplary systems and methods for determining operational integrity of an application or service are described in U.S. Provisional Application No. 61/641,007 entitled “System and Method for Operational Integrity Attestation,” filed May 1, 2012, U.S. application Ser. No. 13/559,707 entitled “System and Methods for Orchestrating Runtime Operational Integrity,” filed Jul. 27, 2012 and published as U.S. Patent Publication No. 2013/0298243 on Nov. 7, 2013, and U.S. application Ser. No. 13/741,878 entitled “Runtime Risk Detection Based on User, Application and System Action Sequence Correlation,” filed Jan. 15, 2013 and issued as U.S. Pat. No. 8,850,517 on Sep. 30, 2014. These three documents are incorporated herein by reference in their entireties.

This description provides exemplary embodiments only, and is not intended to limit the scope, applicability or configuration of the invention. Rather, the ensuing description of the embodiments will provide those skilled in the art with an enabling description for implementing embodiments of the disclosed methods and systems. Various changes may be made in the function and arrangement of elements without departing from the spirit and scope of the invention as set forth in the appended claims. Thus, various embodiments may omit, substitute, or add various procedures or components as appropriate. For instance, it should be appreciated that in alternative embodiments, the methods may be performed in an order different than that described, and that various steps may be added, omitted, or combined. Also, features described with respect to certain embodiments may be combined in various other embodiments. Different aspects and elements of the embodiments may be combined in a similar manner.

The methods for determining real-time operational integrity of an application or service operating on a computing device will now be described by reference to the accompanying drawings in which like elements are described with like figure numbers.

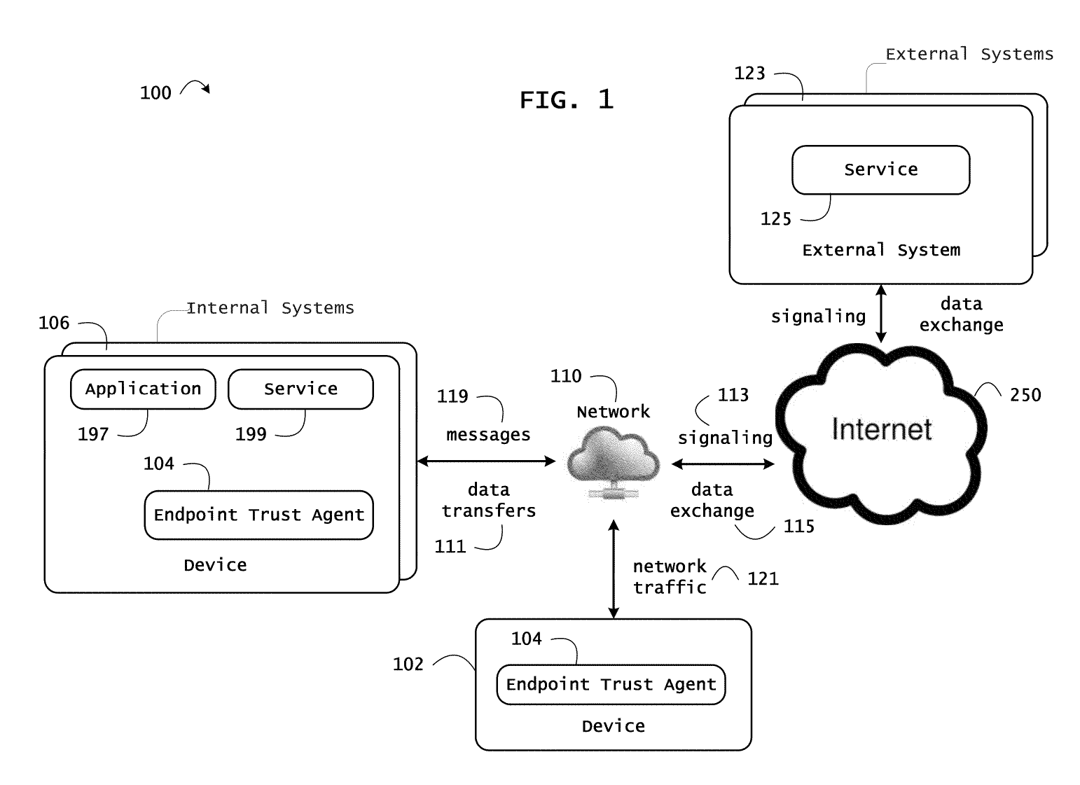

FIG. 1 illustrates one example of an environment 100 that includes internal systems 106 that are connected through a network 110 to the Internet 250, and external systems 123 that are also connected to the Internet 250. The external systems 123 include at least one service 125 that exchanges data with other parties through the Internet 250. The internal systems 106 comprise a plurality of groups of systems, one of which may include at least one application 197 and/or service 199 that transmits messages 119 across the network 110. These internal systems 106 employ data transfers 111 across what may be considered an internal network 110 and ultimately results in a data exchange 115 with other parties through the Internet 250. The data exchange 115 with other parties may include signaling 113 across the network 110.

The example environment 100 shown in FIG. 1 also includes an endpoint trust agent 104 with at least one of the groups of systems, and another endpoint trust agent 104 that is deployed as a computing device 102 on the network 110. The endpoint trust agent 104 deployed as a computing device 102 is therefore not necessarily associated with a group of systems. This instance of the endpoint trust agent 104 is in some embodiments a computing device that may monitor all of the network traffic 121 that passes through the network 110, and not only the traffic emanating from certain internal systems or groups of systems.

In some embodiments, multiple endpoint trust agents 104 may be deployed in various locations throughout an enterprise's environment 100 including multiple locations within the internal network 110 and within multiple internal systems 106. These multiple instances may be executed on separate hardware for additional redundancy and other advantages, or may be executed on shared hardware for improved efficiencies and other advantages. A plurality of endpoint trust agents 104 may cooperate in order to ensure real-time operational integrity of the application or system. In still further embodiments, the plurality of endpoint trust agents 104 may each dedicate themselves to one or more tasks. For example, one endpoint trust agent 104 may dedicate itself to monitoring network traffic entering the environment 100, and another endpoint trust agent 104 may dedicate itself to monitoring network traffic exiting the environment 100. In still further embodiments, endpoint trust agents 104 may coordinate with each other in order to accommodate unexpectedly increased traffic loads. As another example, during periods of high traffic loads, multiple endpoint trust agents 104 may cooperate so that the traffic may be properly examined and any threats that exist are detected and neutralized.

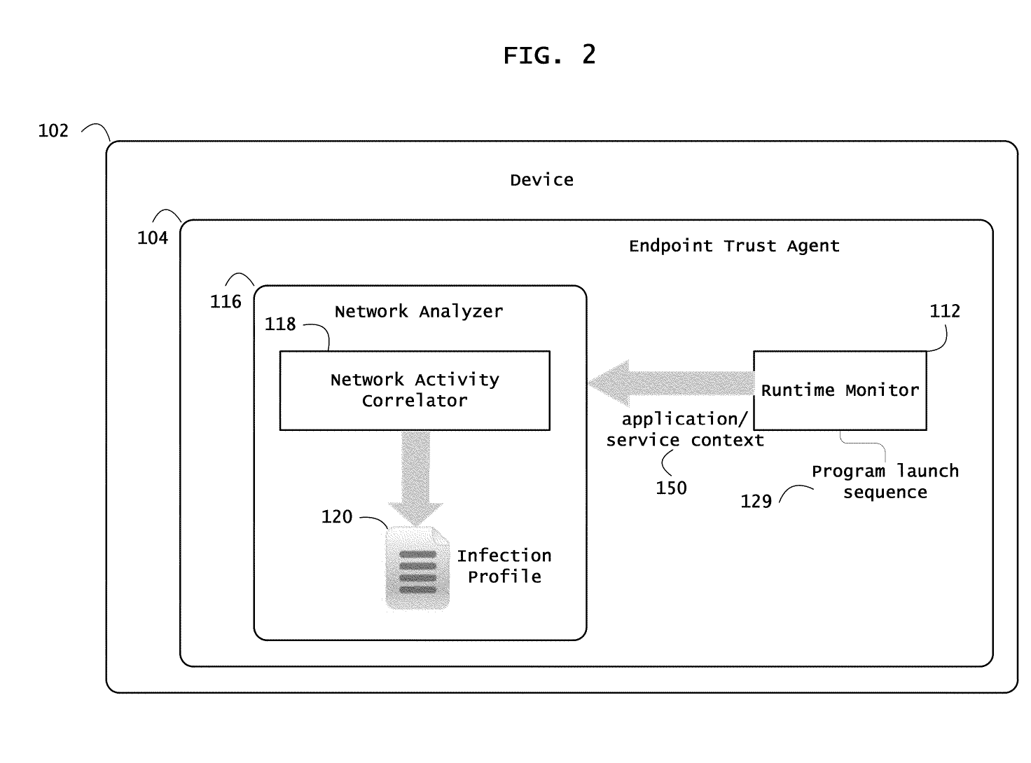

An example embodiment of the endpoint trust agent 104 being implemented on computing device 102 is depicted in FIG. 2. Although FIG. 2 illustrates the endpoint trust agent 104 as a separate entity, the description regarding this embodiment of the endpoint trust agent 104 should be considered to apply to other possible embodiments of the endpoint trust agent 104 that are implemented, for example, in conjunction with aspects of the system that may execute on the same computing device 102. The endpoint trust agent 104 includes a network analyzer 116 and a runtime monitor 112. The network analyzer 116 may include a network activity correlator 118 that receives alerts from aspects of the network. The network activity correlator 118 also provides warnings that result from the network activity correlation and outputs these warnings to a trust supervisor 122. The network analyzer 116 may be implemented through the usage of a socket monitor that is configured to inspect network traffic sent or received by applications and services executing on the computing device 102. In some embodiments, the socket monitor monitors traffic that is being transmitted across the network 110 and is not specifically directed to or from the computing device 102. Other techniques of directing traffic to the network analyzer 116 may be employed but are not specifically enumerated here including the use of a network interface operating in promiscuous mode. The network analyzer 116 is able to obtain the information necessary for the network activity correlator 118 to determine signaling and data exchange integrity, among other aspects.

In some embodiments, the network analyzer 116 is implemented as an apparatus for detecting malware infection. One description of such a network analyzer 116 with a network activity correlator 118 is described by U.S. application Ser. No. 12/098,334 entitled “Method and apparatus for detecting malware infection” and filed on Apr. 4, 2008. This application's disclosure is incorporated by reference herein.

In some embodiments, a runtime monitor 112 may cooperate with the network analyzer 116 to identify malicious applications or services which may be executing on the computing device 102. The runtime monitor 112 may provide, for example, the application/service context 127 for an application or service being examined. Identification of malicious applications or services occurs when certain applications or services may be associated with infection profiles 120 by the network activity correlator 118. The runtime monitor 112 may consider the program launch sequence 129 when cooperating with the network analyzer 116 to identify malicious applications or services. In some embodiments, the program launch sequence 129 may be referred to as a process tree and describes the processes that have been executed in order to execute the monitored application 197 or service 199. Other types of information may be considered by the runtime monitor 112 to determine whether a particular application or service is malicious.

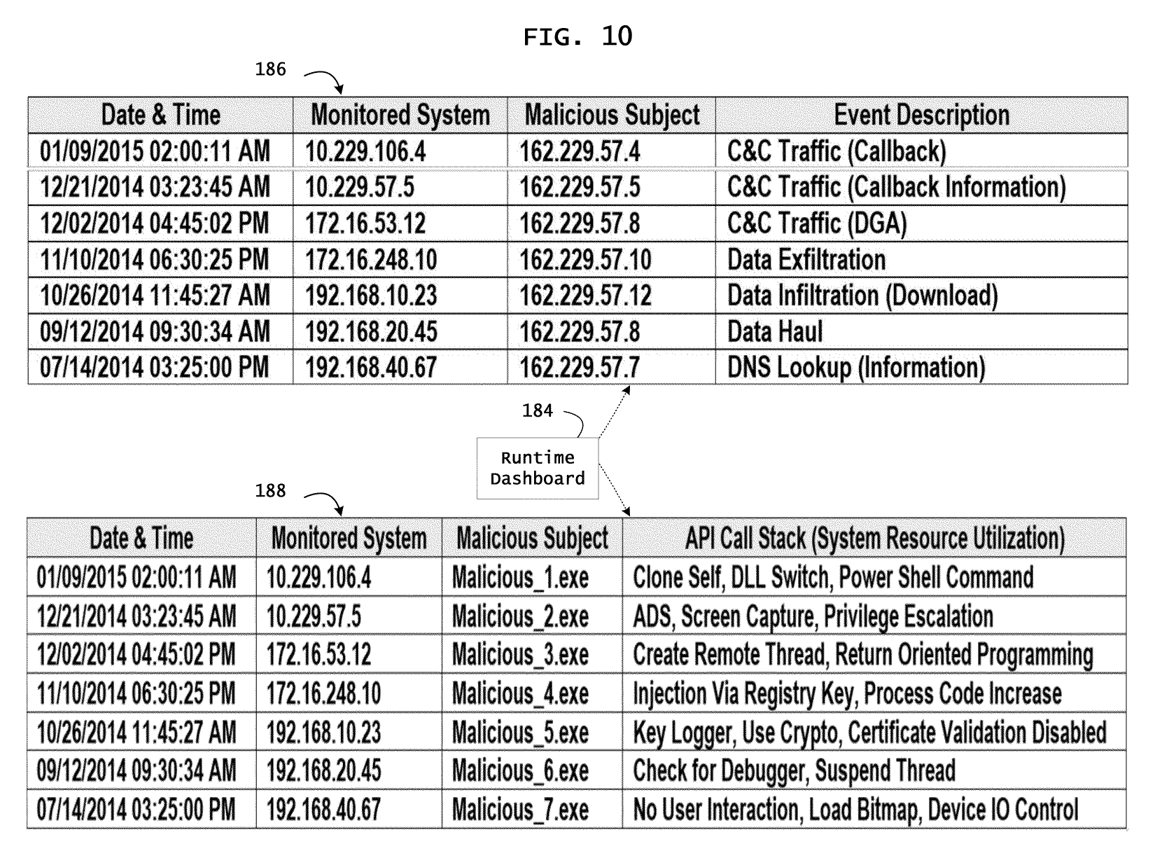

The runtime monitor 112 may consider the sequence of executable code block invocations of operating system, platform and/or framework application programming interfaces (APIs). In some embodiments, the sequence of invocations may be referred to as the API call stack 188 as illustrated in FIG. 10

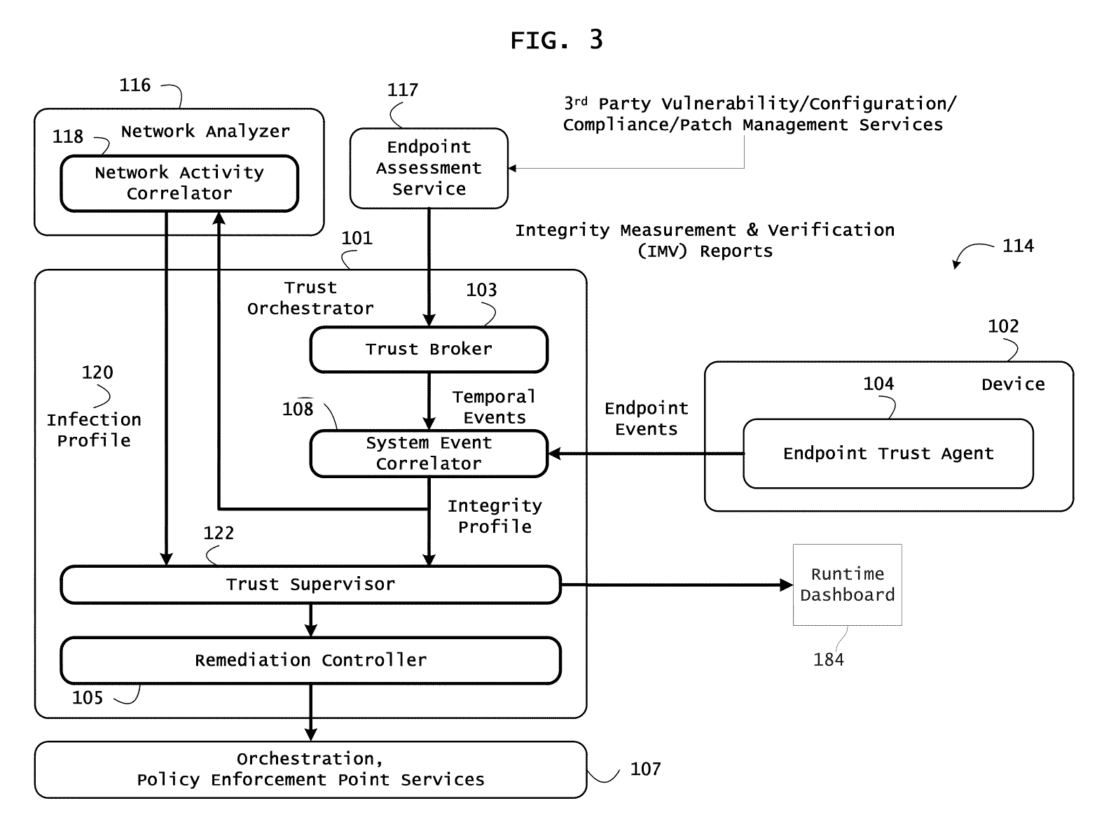

FIG. 3 illustrates one embodiment of a trust orchestration architecture 114 that correlates a plurality of events for determining the operational integrity of a system. It includes an endpoint assessment service 117 receives information from third party vulnerability, configuration, compliance, and patch management services. This information is provided to a trust orchestrator 101. A network analyzer 116 with a network activity correlator 118 also provides information to the trust orchestrator 101. In particular, the network activity correlator 118 provides network threat information to the trust orchestrator 101. In some embodiments, the network activity correlator 118 also receives information from the trust orchestrator 101. One example of such information is the integrity profile. A trust broker 103 that receives information from the endpoint assessment service 117 transmits temporal events to a system event correlator 108.

A computing device 102 may also provide endpoint events to the trust orchestrator 101. In particular, an endpoint trust agent 104 of the computing device 102 may provide endpoint events to the system event correlator 108.

The trust orchestrator 101 includes functional components such as the trust broker 103, system event correlator 108, a trust supervisor 122, and remediation controller 105. In some embodiments, the trust orchestrator 101 is configured to receive active threat intelligence (profiles) from network analyzer 116, endpoint assessment services 117, and endpoint trust agents 104 on devices 102.

The third party endpoint assessment service 117 receives information regarding vulnerabilities, configuration, compliance, and the patch status of different systems and services that exist in the environment. Integrity measurement and verification reports are created after the third party endpoint assessment service 117 has processed the received information. The information is generated in these reports by actively monitoring aspects of the environment from equipment deployed within the environment, or through externally hosted equipment that accesses the environment through controlled conduits such as an open port in the network firewall. For example, one of these external services may report an alert indicating that a violation with an associated severity score for a monitored system. The third party endpoint assessment service 117 transforms this information into a normalized format for consideration by the trust orchestrator 101.

The trust broker 103 retrieves reports from the endpoint assessment services 117 and generates temporal events that provide the system event correlator 108 information related to the damage potential of any malicious activity on the device. The temporal information is at least in part based on the reports provided by the endpoint assessment service 117 and provide a snapshot in time of the state of the system while being agnostic to runtime aspects of the system including applications. In one embodiment, the reports are represented in a markup language such as, but not limited to, Extensible Markup Language (XML).

The trust broker 103 can also be configured to parse, normalize and collate received the reports. In accordance with embodiments, the parsing, normalizing, and/or collating can be based on one or more object identifiers. Exemplary object identifiers can include, but are not limited to, machine hostnames, IP addresses, application names, and package names. This parsing, normalization, and collation (collectively, processing) generates temporal events that annotate the state of the endpoints (devices) at scan time.

Temporal events can be expressed as assertions about operational parameters (e.g., vulnerabilities, compliance, patch level, etc.) based on enterprise policies established for a baseline configuration. The trust broker 103 serves as a moderator that aggregates endpoint operational state measurement.

The system event correlator 108 considers temporal events and endpoint events to generate an integrity profile. The system event correlator 108 can be configured to receive temporal events that measure the integrity of the system at last scan, and endpoint events from the endpoint trust agent 104 that measure the runtime execution state of applications. The system event correlator 108 can be further configured to map the events to a cell in a risk correlation matrix grid and processes the triggered system warnings to evaluate threats by category (or vectors). In one embodiment, the categories include at least resource utilization, system configuration, and application integrity. Each category is assigned a metric that is an indicator of the level of runtime operational integrity that may be asserted based on the system warnings and threat classification produced by the risk correlation matrix.

The system event correlator 108 can also be configured to generate an integrity profile for the device that describes the security risks and threats posed by the measured execution state of running applications on the device. The integrity profile represents an aggregation of system warnings (threats such as malware) identified based on the received temporal and endpoint events. In one embodiment, the format (schema) of the integrity profile is a standard Extensible Markup Language (XML) notation. In some embodiments, the system event correlator 108 considers other types of information to generate an integrity profile. The integrity profile may be passed to the network analyzer 116 for consideration in conjunction with network information so that more complete information may be provided to the trust orchestrator 101 by the network analyzer 116. In particular, the network activity correlator 118 may consider the integrity profile in conjunction with network information to make a determination as to whether a particular application or service may be associated with an infection profile 120.

A trust supervisor 122 of the trust orchestrator 101 may receive the integrity profile along with information from the network activity correlator 118 such as the infection profile 120. The trust supervisor 122 considers this information and determines the appropriate classification and forensic confidence for a particular monitored application or service. In some embodiments, at least some of this information is then presented to an operator so that the operator may consider the events being detected by the endpoint trust agent 104 and take any necessary action. Some embodiments will also pass this information to a remediation controller 105 so that appropriate action may occur without requiring operator intervention.

The remediation controller 105 receives information from the trust supervisor 112 and uses action thresholds and triggers to determine the appropriate response. In some embodiments, the remediation controller 105 receives action request from the trust supervisor 122. Upon receipt of information that satisfies the requirements to trigger a response, the remediation controller 105 transmits directives to the orchestration and policy enforcement point services 107 so that machine level, flow level, or transaction level remediation is effectuated. In some embodiments, the remediation controller 105 may employ a combination of multiple techniques to more effectively address malicious applications or services operating in the environment. For example, the remediation controller 105 may direct both machine level and flow level remediation occur in an effort to anticipate any responses the malicious actors may employ in an effort to prevent detection and removal.

An orchestration and policy enforcement point service 107 receives the determination from the remediation controller 105 and dispatches directives to a plurality of policy enforcement services to perform remediation action at a transaction, flow, system, or application level. Examples of these enforcement services include network firewalls and network switches, intrusion prevention systems, and anti-virus systems. In some embodiments, the directives are transmitted to other endpoint trust agents 104 located elsewhere on the network 110. In some embodiments, the orchestration and policy enforcement point service 107 operates autonomously and accesses the necessary enforcement services through application programming interfaces or other remote control techniques so that minimal operator intervention is necessary. Examples of such vendor APIs include VMWARE™ vCloud APIs, BMC Atrium™ APIs for accessing a BMC Atrium™ configuration management database (CMDB) from BMC Software, Inc., Hewlett Packard Software Operations Orchestration (HP-OO) APIs, and standard protocols such as Open Flow.

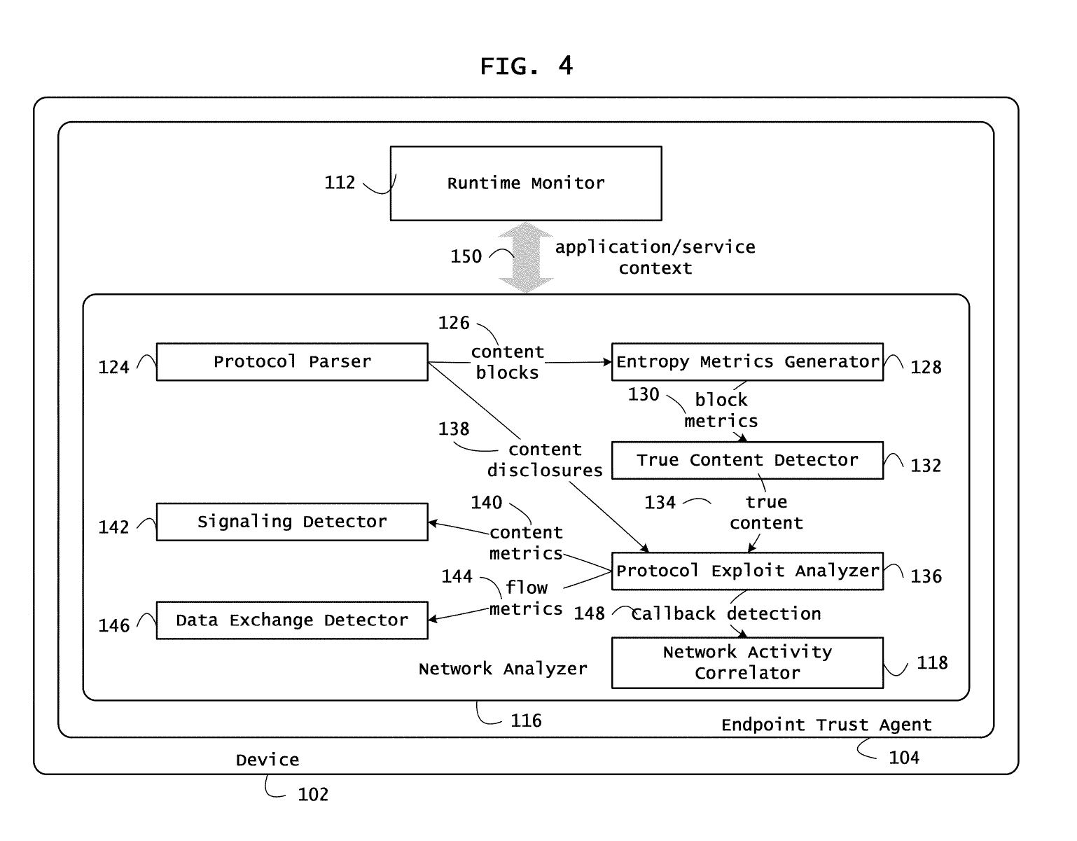

FIG. 4 illustrates one example of a computing device 102 with a runtime monitor 112 and illustrates in greater detail the aspects of one embodiment of the network analyzer 116. As shown in FIG. 4, this embodiment of the runtime monitor 112 passes the application and service context 150 to and from the network analyzer 116. In this embodiment, the network analyzer 116 employs a protocol parser 124, a signaling detector 142, a data exchange detector 146, an entropy metrics generator 128, a true content detector 132, a protocol exploit analyzer 136, and a network activity correlator 118. These and other aspects of the network analyzer 116 exchanges real time assertions and information between system components to establish evidence of malicious intent relating to an application or service being monitored. For example, content blocks 126, block metrics 130, true content 134, content disclosures 138, content metrics 140, flow metrics 144, and callback detection information 148 are considered by the various aspects of the network analyzer 116.

The protocol parser 124 examines the communications to determine which aspects correspond to content blocks 126 and which aspects correspond to content disclosures 138. In some embodiments, the protocol parser 124 can determine the protocol being used based purely on the content being analyzed. In certain embodiments, the protocol parser 124 may also consider other information such as the ports being used for communication, the application or service that is executing the protocol, and other information that may be provided by the runtime monitor 112 through the application/service context 150.

The signaling detector 142 considers content metrics 140 to determine if the messaging constitutes a callback method employed by malicious software. One embodiment of the signaling detector 142 uses threat grammar to make this assessment. The data exchange detector 146 considers flow metrics 144 to determine if data infiltration or exfiltration is in progress. The data exchange detector 146 may also use the threat grammar to make this determination.

Content blocks 126 identify one or more samples of a payload that constitute a discrete content type. For example, a protocol like HTTP may define the payload included with a transmission such as an image file, an application octet stream, or other types of data. The content blocks 126 may be extracted from any arbitrary portion of the payload for consideration. The content blocks 126 that are extracted may be of any appropriate size. In some embodiments, a plurality of samples across different portions of the payload may constitute the content blocks 126. In certain embodiments, the plurality of samples is extracted across different content delimiters that are defined by the protocol. In some embodiments, the selection of the portions of the payload sampled and the size of the sampled portions may vary as necessary to minimize the computation overhead during runtime, to increase network throughput, or to more carefully inspect potentially suspicious traffic, among other factors. In one exemplary embodiment, the sample size may be as small as 16 bytes and as large as the entire header epilogue in the payload.

The entropy metrics generator 128 uses the content blocks 126 provided by the protocol parser 124 to derive block metrics 130 for the content blocks 126. The block metrics 130 may include an entropy fingerprint. When generating the block metrics 130, the entropy metrics generator 128 may consider the entirety of the content blocks 126. This type of analysis is applicable when, for example, certain portions of the content of the content blocks 126 include header information or other information that does not contribute to the entropy of the communication. In some embodiments, the sampled portions of the content blocks 126 are selected to maximize the entropy to be gathered so that a more reliable entropy fingerprint is obtained. Other techniques of optimizing the entropy fingerprint are contemplated but not specifically listed.

The entropy metrics generator 128 may consider an arbitrary portion of information from the content blocks 126 to determine the entropy fingerprint. In some embodiments, the entropy metrics generator 128 need only sample a small portion of the content to generate sufficient usable entropy for an entropy fingerprint. This is particularly desirable when the number and volume of content blocks 126 to be monitored is high and when the available computing resources are limited. Other aspects, such as the desired reliability of the entropy fingerprint and the amount of information that may be sampled from the content blocks 126, may also be considered by the entropy metrics generator 128 when determining the amount of information to be sampled and the location from which the information should be sampled. Some embodiments of entropy metrics generators 128 can dynamically adjust the samples so that more computationally expensive entropy fingerprints are only derived when higher accuracy is desirable, and more computationally efficient entropy fingerprints are used in the normal course of operation. In one example embodiment, an entropy metrics generator 128 reliably discriminates between ASCII text, UNICODE text, obfuscated, and encrypted communications.

The entropy metrics generator 128 may also generate statistical markers for inclusion with the block metrics 130. For example, means, standard deviations, chi-squared statistical distributions, probability distributions, serial correlation coefficients, and n-gram analysis may be included with the block metrics 130. Other types of pertinent statistical markers may be included with the block metrics 130 but are not specifically enumerated here. In some embodiments, additional markers and information may be included with the block metric 130 so that a more useful descriptor of the content block 126 can be provided. These additional values may be generated by the entropy metrics generator 128 or may be simply embedded with the block metrics 130 by the entropy metrics generator 128.

The entropy metrics generator 128 may rely on multiple samples to generate the block metrics 130 for a particular communication. This may be desirable in situations when different aspects of the payload may exhibit different characteristics resulting in different block metrics 130 and fingerprints. By considering multiple aspects of the communication, the entropy metrics generator 128 may allow for a more accurate determination as to whether or not the content block 126 of the communication being monitored is malicious.

True content 134 is determined by the true content detector 132 and specifies the actual type of the content block 126 being considered. This value is derived from the content block 126 because it is possible for malicious actors to disguise their traffic using an inaccurate type description for the content block 126. At least one true content 134 exists per contact block 126. In some embodiments, true content 134 may identify code or other possible command constructs that are contained in the content blocks 126 and identified by the true content detector 132. In some embodiments, the true content 134 may be based on the type identifiers used for a particular protocol. For example, when the protocol is of the HTTP standard, the true content value may be “application/pdf” for an actual PDF file, or “image/gif” for an actual GIF file. In some embodiments, the true content 134 value is not tied to the specific types defined by the protocol. In some embodiments, the true content value 134 accommodates sufficient information so that an accurate description of the content block 126 is provided. One example of such an embodiment generates both a type and a subtype for the content block 126 being analyzed. Another example true content 134 identifies a plurality of types of content contained in one content block 126.

The true content detector 132 uses information including the block metrics 130 generated by the entropy metrics generator 128 to determine the actual content in the content block 126. When the block metrics 130 including the entropy fingerprint provide sufficient information to determine with a sufficient level of confidence that the content is of a particular type, the true content detector 132 transmits the true content 134 to the protocol exploit analyzer 136. In some embodiments, different levels of confidence will be needed to determine if content is of a particular type. For example, some types of content may be easily identifiable when the entropy fingerprint is not an exact match because other aspects of the block metrics 130 provide a reliable match to a particular type of content of the content block 126.

Content disclosure 138 describes the content type of the content block 126 that a sender has declared. The content disclosure 138 corresponds to the standard content types that are enumerated for particular protocols. In some embodiments, the content disclosure 138 does not correspond to the specific enumerations defined by the protocol due to unofficial standards, error, or other reasons. At least one content disclosure exists per content block 126. The difference between the content disclosure 138 and the true content 134 is that the content disclosure 138 is defined by the sender, and is not verified by the receiver.

When extraneous content is included with a communication, the content disclosures 138 may not correctly identify or may fail to identify the extra content of the communication. The extraneous content may, for example, be inserted into the content by an undetected malicious actor. Although receivers complying with the appropriate protocols may discard or otherwise ignore the extraneous content, the extraneous content may contain information usable by malicious receivers. The true content 134 derived by the true content detector 132 represents the actual information that is being transmitted in the communication, and in some embodiments the true content 134 also represents the extraneous content included with the communication.

The protocol exploit analyzer 136 considers the true content 134 and the content disclosures 138 to determine if the information being transmitted seeks to exploit aspects of a standard protocol. For example, if extraneous content is detected in the communication, and if this information is identified by the true content detector 132, content metrics 140 and flow metrics 144 are derived which are transmitted to the signaling detector 142 and data exchange detector 146 for consideration.

Content metrics 140 describe the methods, syntax, or requested types of information that are associated with the client-server communications. The content metrics 140 may be used to determine whether the messaging being examined is malicious. For example, the content metrics 140 may be used to determine if the communications are attempts by malicious threats to contact a command and control server or another controlling entity.

Flow metrics 144 contain information useful for determining whether the communications being examined by the endpoint trust agent 104 are attempts at data exfiltration. The flow metrics 144 may include information regarding the volume, the time and date, and the duration of data transfers. In some embodiments, the flow metrics 144 may include information regarding the systems participating in the communications event. In some embodiments, the flow metrics 144 may provide sufficient information to determine the specific protocol being used for the communications event. For example, the flow metrics 144 may provide the information needed to determine that 1 GB of information has been transferred under the guise of a DNS query within a one-hour period of time. Other flow metrics 144 may involve comparing the typical data exchanges that have occurred in a previous period of time for previous events and the currently occurring data exchanges, comparing the typical data exchanges for similar applications and services that have executed previously, and other comparative analysis.

Callback detection context 148 provides the context to identify the application or service instance that is associated with the activity. In some embodiments, this identification will specify the process used by the application or service that is executing. In other embodiments, the groups of processes being used by the executing application or service will be identified. The callback detection context 148 may include the launch sequence based on the parent/child relationship between processes and/or specific interactions between the user and other aspects of the system and the application or service being monitored. One example of interactions between the user and the application or service being monitored includes keystrokes entered by the user and the content displayed on the screen in response to user commands.

Examples of interactions with the system include accessing certain memory blocks or accessing local or remote resources through the use of direct I/O through the file system driver or through standard APIs. One example is when an HTTP POST request is initiated as the initial request without an associated application or service context. Such an HTTP POST request is not associated with an act by an application or service, and is also not associated with an act by the user. This interaction is identified through the use of the callback detection context 148, among other aspects, as possible malicious communication by a malicious actor. Another example is when unnecessary content is included in a HTTP GET request. This interaction is also similarly identified as possible malicious communication by a malicious actor.

In some embodiments, interactions between aspects of the system and the monitored application or service may include invocations of system level APIs or library APIs during the lifetime of the monitored application or service. The callback detection context 148 may include information specifically identifying the application or service being executed and the call stack for the executing application or service. One example of such identifying information includes the full path and filename referring to the code being executed. By including this and other types of information, the callback detection context 148 may help detect applications or services that, for example, initiate unsolicited communications with external servers without explicit user interaction. Another example scenario that may be detected by the callback detection context 148 involves an authenticated user's credentials being used to approve egress of data through systems such as a firewall.

The callback detection context 148 is utilized by the network activity correlator 118 to determine the application or service associated with the callback detection context 148. In particular, the application or service context 150 from the runtime monitor 112 is utilized to determine the application or service that is causing the network activity associated with the callback detection context 150.

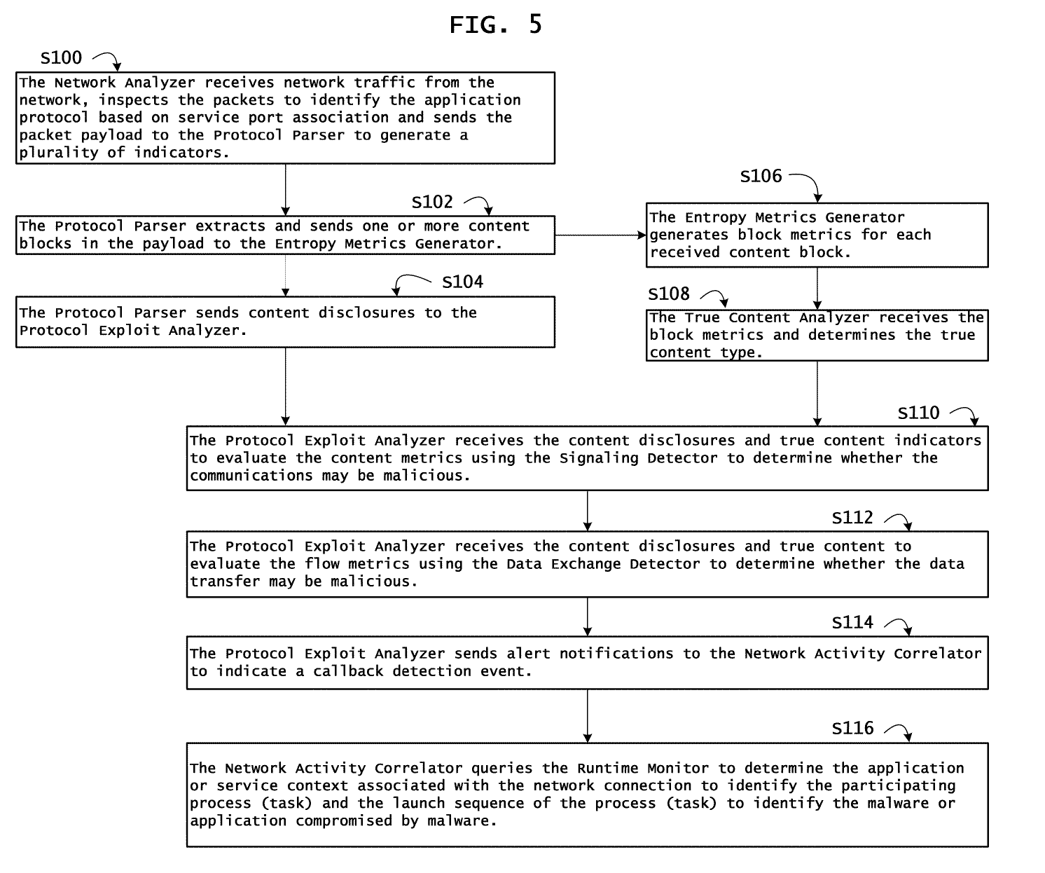

FIG. 5 depicts a series of steps that are executed by the network analyzer 116 after receiving traffic from the network 110. At step S100, the network analyzer 116 receives the traffic, inspects the packets to determine the application protocol being used, and sends the packet payload to the protocol parser 124 to generate a plurality of indicators. In some embodiments, the network analyzer 116 relies on the service port to identify the application protocol. In other embodiments, aspects of the data being transmitted across the network such as the header may be used to determine the application protocol. For example, if the header is consistent with an HTTP header, the network analyzer 116 may determine the traffic is in fact an HTTP request or response. At step S102, the protocol parser 124 extracts and sends one or more content blocks 126 from the payload to the entropy metrics generator 128 based on the threat grammar. In some embodiments, the content blocks 126 may be name-value pairs or other forms of known data containers utilized in the payload. The protocol parser 124 sends content disclosures contained in the payload including transport and application metadata to the protocol exploit analyzer 136 (step S104). The entropy metrics generator 136 generates block metrics 130 for the received content block 126 and sends this information to the true content detector 132 for consideration (S106). At step S108, the true content detector 132 uses the block metrics 130 and determines the true content type and sends this determination to the protocol exploit analyzer 136. The protocol exploit analyzer 136 receives content disclosures and true content indicators from the protocol parser 124 and the true content detector 132 and makes a determination whether or not the communications may be malicious (S110, S112). The protocol exploit analyzer 136 may use this information to evaluate the content metrics 140 (S110) and the flow metrics (S112) to help provide the information necessary to determine if the communications are malicious. For example, the protocol exploit analyzer 136 may use the signaling detector 142 to determine if a callback or other communication to malicious command and control infrastructures is in progress. When evaluating the content metrics 140, the protocol exploit analyzer 136 attempts to determine if the communications constitute callback beacons or other malicious communication (S110). When considering the flow metrics, the protocol exploit analyzer 136 attempts to determine if the data transfer constitute a malicious exfiltration of information (S112). After these determinations (S110, S112) are made, the protocol exploit analyzer 136 transmits notifications to the network activity correlator 118 to indicate that a malicious communication or data transfer has occurred (S114). The network activity correlator 118 uses information from sources such as the runtime monitor 112 to determine if the application or service context 150 that is associated with the network connection to identify the application or service and the launch sequence of the application or service is malicious (S116).

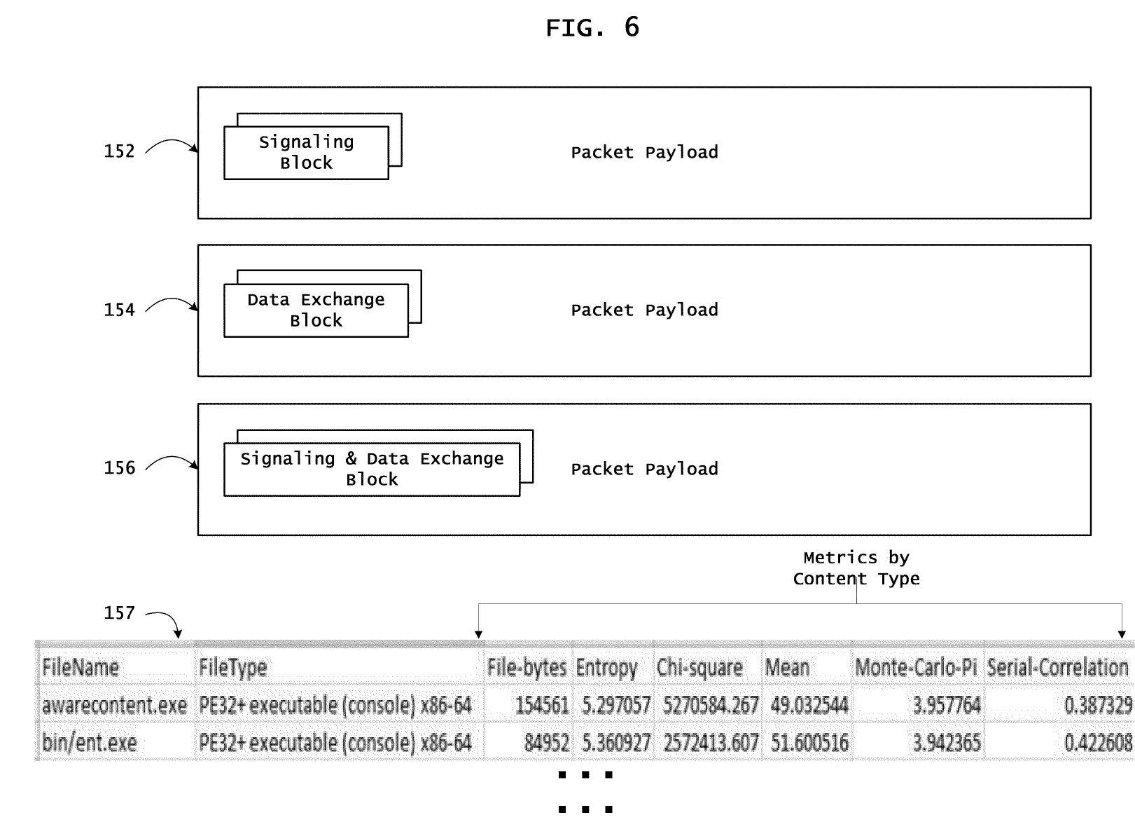

FIG. 6 illustrates examples of how messages may be communicated by malicious threats through one or more signaling and/or data exchange blocks in a payload. Threats may use, for example, the signaling blocks of the packet payload 152, data exchange blocks of the packet payload 154, or both the signaling and data exchange blocks of the packet payload 156. Other combinations of signaling blocks and data exchange blocks may be used by malicious threats in a packet payload.

FIG. 6 also illustrates an example list 157 that identifies the file name, the file type of the application or service being monitored, and the file size. The example list 157 also includes an example set of metrics including entropy, chi-square, mean, monte-carlo-pi, and serial-correlation values. The example list 157 is only depicted as an example and does not limit the other types of metrics and information that may be considered and/or displayed.

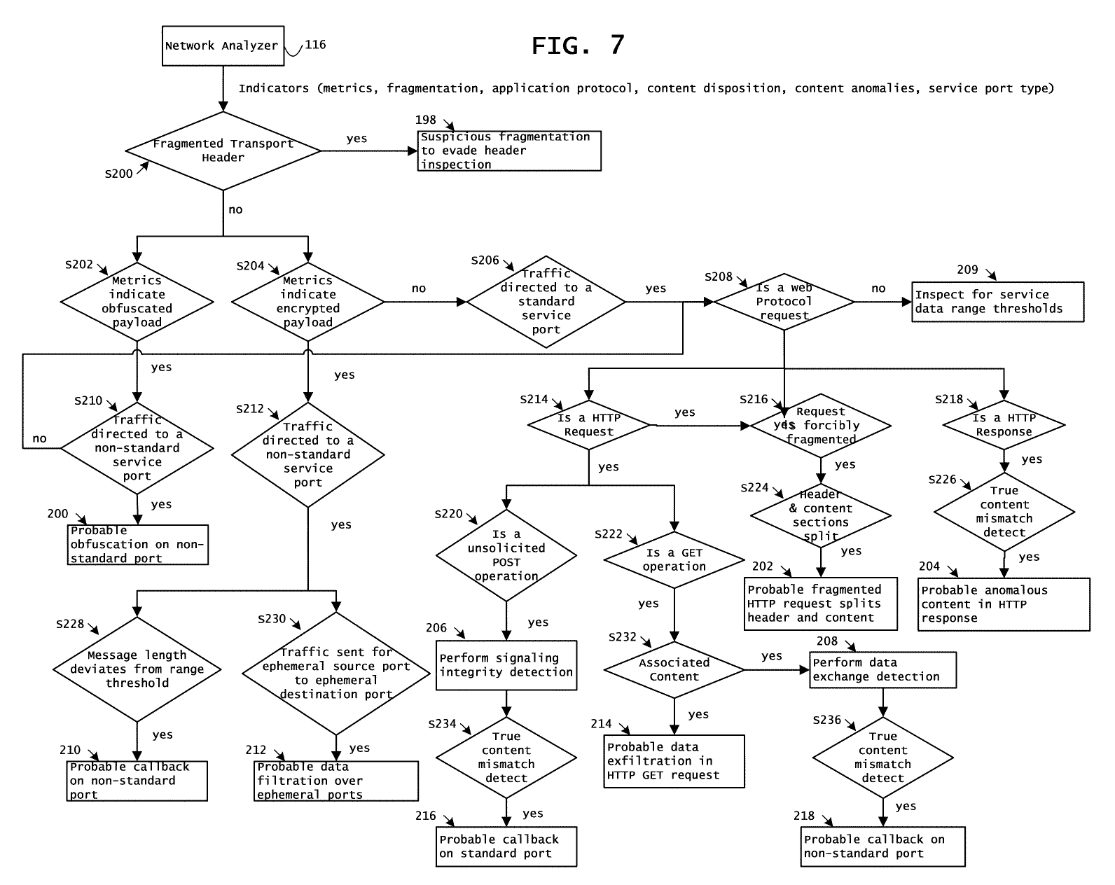

FIG. 7 depicts one example of the algorithm employed by some embodiments of the system for determining the trustworthiness of the signaling and data exchange between network systems. When not specifically described, the algorithm considers as possible indicators the metrics, fragmentation, application protocol, content disposition, content anomalies, and service port types, among other information described in the algorithm. When aspects of this example algorithm omit a path resulting from an unillustrated decision, the result is the algorithm exits. For example, if the traffic is not directed to a standard service port (S206), the algorithm exits.

In this example algorithm, indicators are provided and determination is made as to whether a fragmented transport header is included (S200). Some types of malicious communications intentionally fragment the transport payload in an effort to avoid traditional detection and defense technologies which tend to rely on signatures. If such a header exists, a determination is made as to whether the fragmented transport header is sufficiently suspicious to constitute an attempt to evade header detection. If the header is deemed suspicious, an alert 198 is issued.

If such a header does not exist, it is determined whether or not the metrics indicate that an obfuscated payload exists (S202) and if the metrics indicate that an encrypted payload (S204) exists. If no obfuscated payload is detected and if no encrypted payload is detected, the algorithm exits. If an obfuscated payload is detected, then it is determined whether or not traffic is being directed to a non-standard service port (S210). If such a non-standard service port is used, it is probable that the communication is an attempt to obfuscate information and is identified by an alert 200. If no such non-standard service port is used, a determination is made as to whether the traffic is a web request (S208).

In the event the metrics indicate that an encrypted payload exists (S204), a determination is made as to whether the traffic is directed to a non-standard service port (S212). If such a non-standard service port is used, then the message length is considered (S228) and a determination as to whether the traffic is being sent from an ephemeral source and to an ephemeral destination ports (S230). If no such non-standard service port is being used, the algorithm exits. When the message length deviates from the range of lengths that are typical for such a communication, the communication is deemed to be a probable attempt at a callback beacon on a non-standard port and such an alert 210 is issued. When ephemeral source and destination ports are being used, the communication is determined to be a probable data exfiltration over the ephemeral ports and the appropriate alert 212 is issued. When the message length does not deviate from the range threshold, or when the traffic is not being sent from an ephemeral source port to an ephemeral destination port, the algorithm exits.

When the payload is not encrypted (S204), a determination as to whether a standard service port is being used is made (S206). If a standard service port is used, a determination may be made as to whether the communication is being made as a standard web request (S208). If a standard service port is not used, the algorithm exits. If this is not a standard web request, an alert is issued 209 requesting inspection of the service data range thresholds. If this is such a web request, it is then determined if the communication is an HTTP request (S214) or an HTTP response (S218). If the communication is neither, the algorithm exits. If the communication is an HTTP response (S218), it is determined if there is a mismatch between the content actually being transmitted versus the content that should be transmitted (S226). If there is a mismatch in the content, a determination is made that the communication contains anomalous content and the appropriate alert is issued 204. If no such mismatch exists in the content, the algorithm exits.

When web request is deemed to be an HTTP request (S214), a determination is made as to whether the request has been forcibly fragmented (S216), whether the HTTP request is an unsolicited POST operation (S220), and if the HTTP request is a GET operation (S222). If none of these (S216, S220, S222) are determined to exist, the algorithm exits. If fragmentation exists (S216), a further determination as to whether the header and content sections have been split (S224) is made. If such splitting of the content has occurred, an alert 202 regarding the fragmented HTTP request splitting the header and content is issued.

If the HTTP request is an unsolicited POST method (S220), signaling integrity detection is performed 206. After signaling integrity detection is complete, it is determined if there exists a true content mismatch (S234). Should there be such a content mismatch, an alert 216 is issued indicating the content is a probable callback beacon being issued over a standard HTTP communication port. If these conditions are not met, then the algorithm exits.

If the HTTP request is instead a GET method request (S222), it is determined if content associated with the GET method request exists (S232). If no content is associated, an alert 214 is issued that indicates possible data exfiltration is occurring through the use of the GET method request. If content is associated with the GET method request, then data exchange detection is performed 208. After this detection is complete, a determination is made as to whether a true content mismatch exists (S236). If such a mismatch exists, then an alert 218 is issued indicating the communication is a probable callback on a non-standard port.

Although FIG. 7 illustrates one possible algorithm, modifications and variations of this algorithm are encompassed by this application. For example, the consideration as to whether standard or non-standard ports are being used may be performed prior to the determination as to whether encrypted or obfuscated payloads are being transmitted. In some embodiments, multiple signals including the true content type 134, whether the content is encrypted or obfuscated, and whether the content is transmitted over non-standard ports are considered by an algorithm to determine if an alert regarding the communication is appropriate. Other types of optimizations in the algorithm and other information that may be considered by the algorithm are not specifically enumerated here.

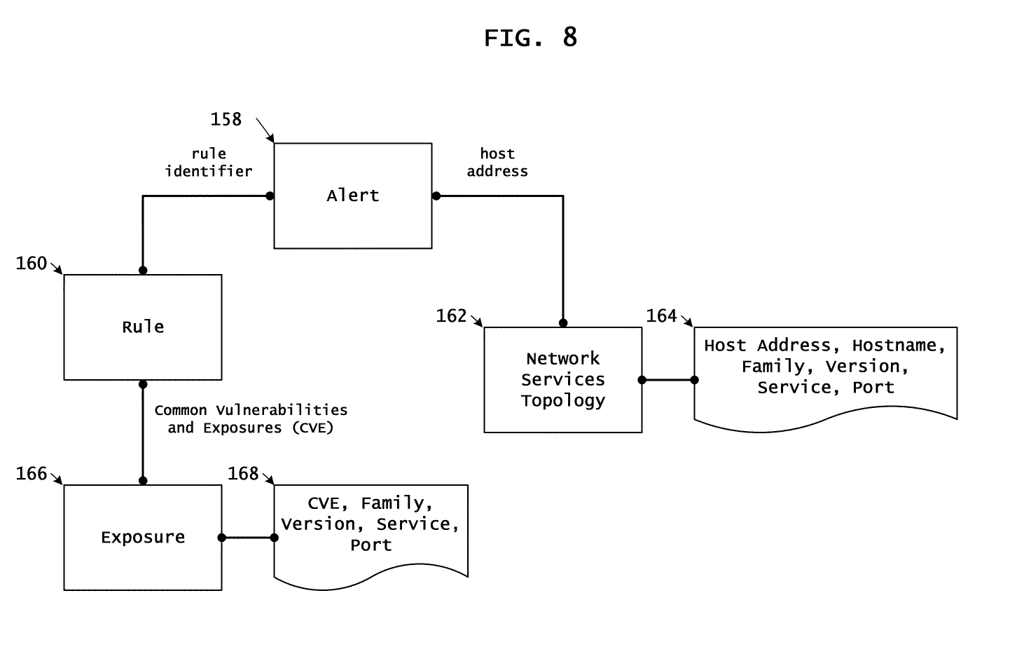

FIG. 8 illustrates how alerts generated by the algorithm executed by the protocol exploit analyzer 136 may be inspected to determine the relevance of the alert 158. Upon receipt of the alert 158, a rule identifier may be used to match the alert with the appropriate rule 160. This rule is then matched with the common vulnerabilities and exposures (CVE) to identify the level of exposure 166 associated with the rule 160. The level of exposure depends on the vulnerability, the family of system affected, the version of the software affected, the particular service exploited, and the port used, among other types of information 168. The alerts 158 are also processed to determine the host address which caused the alert. The alerts 158 are used with the network services topology 162 to determine the specific host address, hostname, family, version, service, port, and other network topographical information 164 that is associated with the alert. These aspects are considered in conjunction with the CVE information so that the relevance of the threat is known. For example, if a particular alert is triggered due to a vulnerability in a Microsoft Windows based system, but the system triggering the alert is not a Microsoft Windows based system, the relevance of the alert is low.

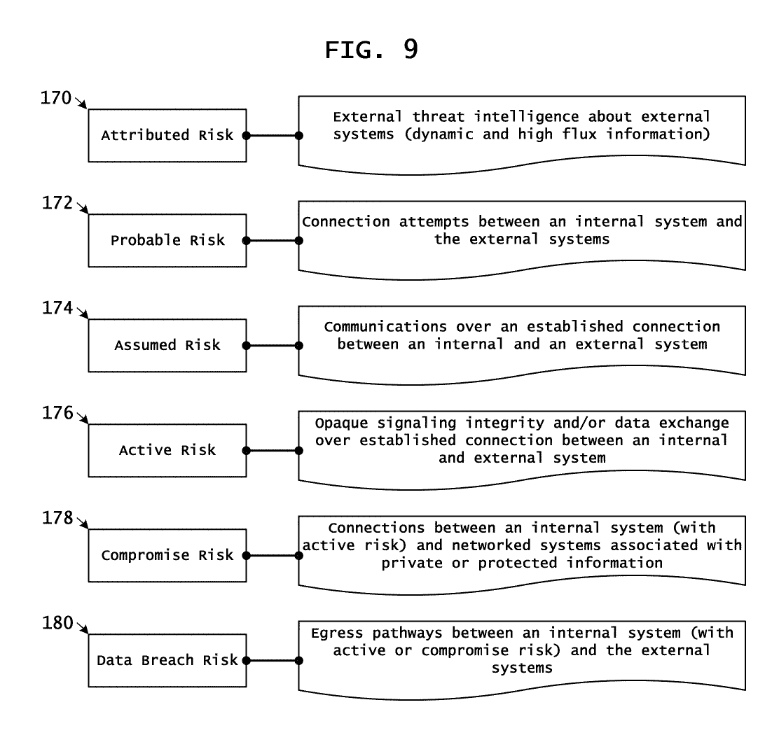

FIG. 9 depicts one example of a risk monitoring model for determining risk scores associated with signaling integrity and data exchange alerts. An attributed risk alert 170 is generated based on external threat intelligence about external systems that exhibit dynamic and high flux information. A probable risk alert 172 is generated based on connection attempts between internal systems and external systems. An assumed risk alert 174 is generated when communications over an established connection between an internal and external system occurs. An active risk 176 may exist when opaque signaling integrity and/or data exchange over an established connection between internal and external systems occur. A compromise risk alert 178 is issued when connections between an internal system (with active risk) and networked systems associated with private or protected information exists. A data break risk alert 180 is generated when egress pathways outbound from the internal network exist between an internal system with active or compromised risk and an external system occurs. The various risk scores help determine the forensic confidence score that is associated with the detected risks. Other types of alerts may be issued depending on the different types of information considered and are not specifically enumerated here.

The included computer program listing in Appendix 1 provides one example of the threat grammar that is specified using expressions in extensible markup languages. In the example threat grammar, the expressions are made in XML. Other types of human readable and binary information may be used to define the threat grammar but are not specifically enumerated here. As shown in the example threat grammar, the aspects of the content considered to determine if the content is of a particular type are configurable. The threat grammar also illustrates how specific entropy values, mean values, chi-square values, monte-carlo-pi values, serial correlation coefficient values, n-gram values, and other information may be used to identify particular threats. In some embodiments, the threat grammar is periodically updated so that the most current and relevant threat grammar may be used to monitor applications or services executing on the computing device 102. The threat grammar specifications define an extensible framework for threat annotations, benchmarks to measure cyber risk and resilience of networked systems, and a schema for cyber threat information sharing between public and private sectors, based on anonymization and tokenization of behavioral profiles, preserving the privacy and confidentiality of personal and organization tier data and meta-data. This provides a dynamic, real-time, and secure protocol for timely sharing of threat information to thwart the proliferation of cyber-attacks across sectors (horizontal and vertical). Standards organizations, for example NIST and MITRE, may benefit from the proposed threat grammar that is agnostic to network signatures, file hashes and post-breach registry and file system footprints, thereby providing enhanced capabilities to detect zero-day (patient zero) attacks based on runtime behaviors.

FIG. 10 illustrates one example view of the runtime dashboard 184. In view 186 of the dashboard, the event description is shown with the date and time, the monitored system, and the malicious subject that has been identified. In view 188, the API call stack is shown with the date and time, the monitored system, and the malicious subject that has been identified. As shown in FIG. 10, the malicious subject may be identified with an IP address or with a full path to the executable associated with the API call stack. Other types of information (for example, a user associated with the activity) may be shown on the runtime dashboard 184 as needed and are not specifically enumerated here.

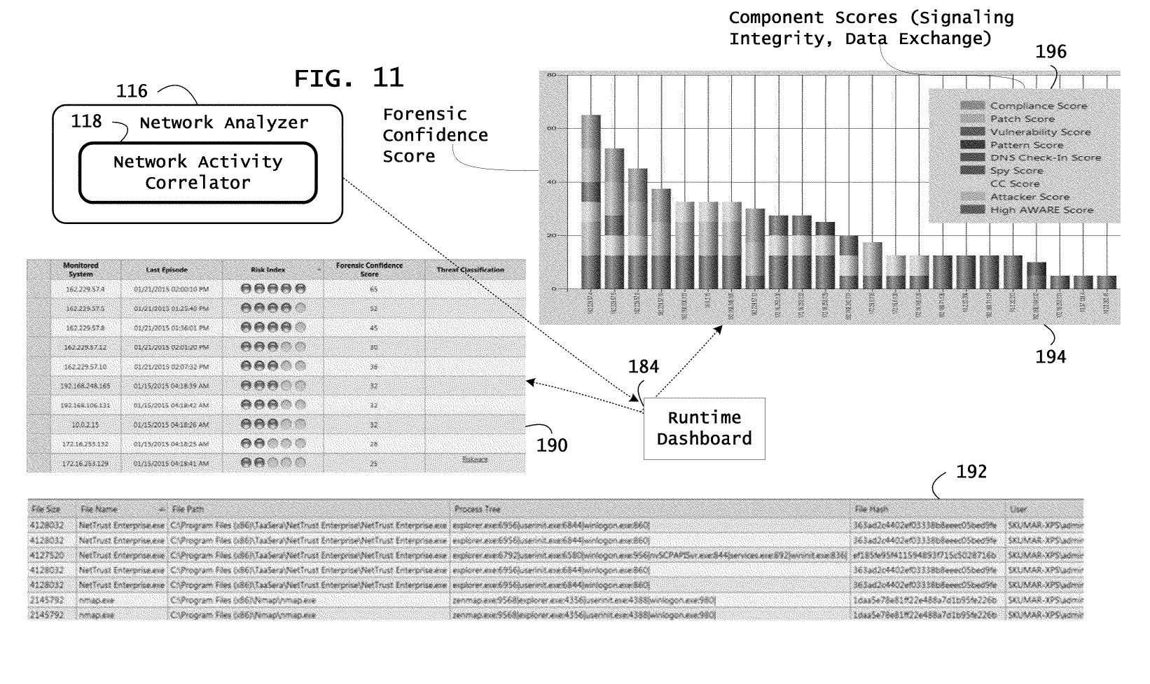

Another depiction of the runtime dashboard 184 is shown in FIG. 11. In this illustration, the network analyzer 116 has provided information to the runtime dashboard 184 which may include information from the network activity correlator 118. This information may be used to generate visual aids for the operator to investigate. For example, in one view the forensic confidence scores are illustrated on a chart 194 with the component scores 196 which are based on the signaling and the data exchange integrity values. In another view 190, the forensic confidence score is illustrated with the threat classification, the risk index, the last occurrence or episode of the threat, and the monitored system. In yet another view 192, the file size, file name, file path, process tree, file hash, and the user under whose permissions the executing process is operating are displayed. These example views 190, 192, 194 are just some of the possible ways to present the information gathered by the components of the system and should not be construed to be the exclusive views available in the runtime dashboard 184. For example, other types of charts may be generated from the types of information gathered by the system, and the operator may be able to specify the presentation of the information in a manner that is most suitable for the current need.

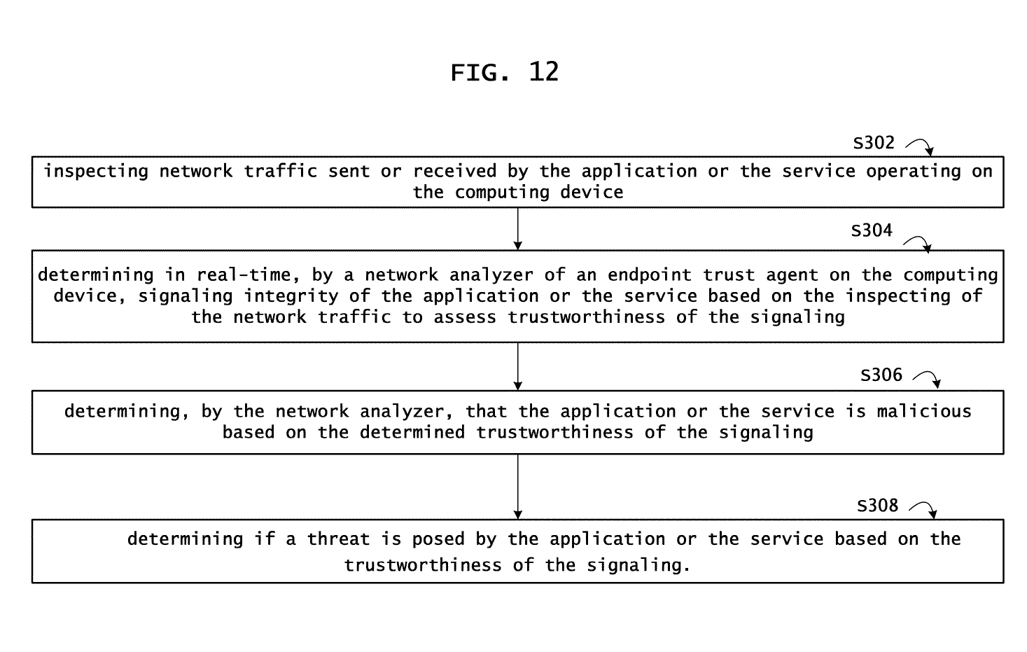

FIG. 12 illustrates a series of steps that are executed to determine if a threat is posed by an application or service on a computing device 102 based on signaling integrity. First, the network traffic sent or received by the service or application operating on the computing device is inspected (S302). Next, a determination is made by the network analyzer 116 of an endpoint trust agent 104 of a computing device 102 regarding the signaling integrity of the application or service (S304). This determination is made through the inspection of the network traffic to determine the trustworthiness of the signaling. A determination is then made by the network analyzer 11 as to whether the application or service is malicious (S306). This determination is based on the trustworthiness of the signaling (S306). Finally, it is determined if a threat is posed by the application or service based on the trustworthiness of the signaling (S308).

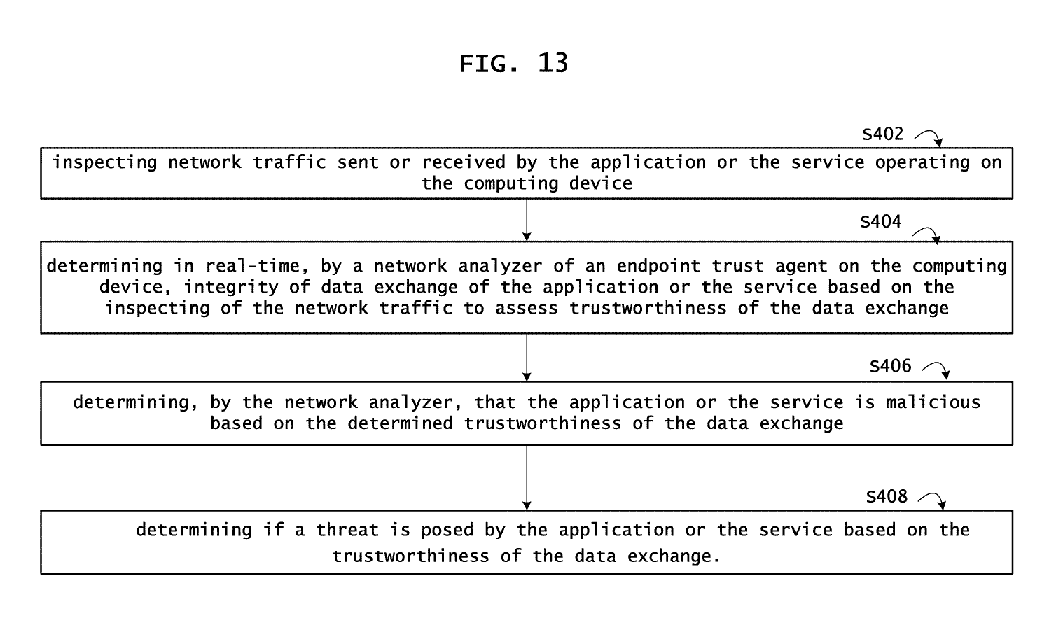

FIG. 13 illustrates a series of steps that are executed to determine if a threat is posed by the application or service based on data exchange. First, the network traffic sent or received by the application or service operating on the computing device 102 is inspected (S402). Next, the network analyzer 116 of the endpoint trust agent 104 on the computing device 102 makes a real-time determination as to the integrity of the data exchange of the application or service based on the inspection of the network traffic (S404). This determination is performed to assess the trustworthiness of the data exchange (S404). A determination is then made by the network analyzer 116 as to whether the application or service is malicious, based on the trustworthiness of the data exchange (S406). Finally, it is determined if the application or service is a threat based on the trustworthiness of the data exchange (S408).

FIG. 13 therefore illustrates a method of determining real-time operational integrity of an application 197 or service 199 operating on a computing device 102, that includes the steps of inspecting network traffic 121 sent or received by the application 197 or the service 199 operating on the computing device 102, determining in real-time the signaling integrity of the application 197 or the service 199 based on the inspecting of the network traffic 121 to assess trustworthiness of the signaling 113, and determining that the application 197 or the service 199 is malicious based on the determined trustworthiness of the signaling 113. Some embodiments of the method also determine if a threat is posed by the application 197 or the service 199 based on the trustworthiness of the signaling 113. Still further embodiments also determine the signaling integrity is determined based on a plurality of content entropy discrepancies (by an entropy metric generator 128) in data blocks 126 associated with messaging between internal or external systems on the network. In some embodiments, the method includes determining the signaling integrity based on a content type mismatch in data blocks 126 associated with messaging between internal or external systems 105, 123 on the network 110. Some embodiments determine the signaling integrity based on a type of service ports associated with messaging between internal or external systems 105, 123 on the network 110, or determine the signaling integrity based on the frequency of messaging attempts between internal or external systems 105, 123 on the network 110. When inspecting the network traffic 121, some embodiments include inspections of the payload of a data packet 152, 154, 156. Some embodiments also determine whether a malicious callback threat is associated with the application 197 or the service 199 when determining the real-time signaling integrity. Some embodiments of the method also include generating a real-time forensic confidence score as a measure of real-time threat relevance of the application 197 or the service 199 and displaying the real-time forensic confidence score, or displaying, in a runtime dashboard 184, real-time status indications for operational integrity of the application 197 or service 199 operating on the computing device 102. In some embodiments, the runtime dashboard 184 is an application integrity dashboard for reputation scoring that displays evidence of an associated application launch sequence for pre-breach detection and breach analysis, a network activity dashboard for reputation scoring that displays a real-time forensic confidence score and evidence of the application 197 or service 199 associated with the activity on the computing device 102, a resource utilization dashboard for reputation scoring that displays an application program interface call stack to identify operating system resources leveraged in an attack, a global view dashboard for reputation scoring that displays a real-time forensic confidence score and a malicious callback associated with a subject or a malicious data, a global view dashboard for reputation scoring that displays a real-time forensic confidence score and a malicious data infiltration associated with a subject, or a global view dashboard for reputation scoring that displays a real-time forensic confidence score and a malicious data exfiltration associated with a subject.

Other embodiments of the method of determining real-time operational integrity of an application 197 or service 199 include inspecting network traffic 121 sent or received by the application 197 or the service 199 operating on the computing device 102, determining in real-time integrity of a data exchange 115 of the application 197 or the service 199 based on the inspecting of the network traffic 121 to assess trustworthiness of the data exchange 115, determining that the application 197 or the service 199 is malicious based on the determined trustworthiness of the data exchange 115. Some embodiments also include determining if a threat is posed by the application 197 or the service 199 based on the trustworthiness of the data exchange 115. In some embodiments, the integrity of the data exchange 115 is determined based on a plurality of content entropy discrepancies (by an entropy metrics generator 128) in data blocks 126 associated with the data transfer 117 between internal or external systems on the network 110. In other embodiments, the integrity of the data exchange is determined based on a content type mismatch (for example by true content detector 132) in data blocks associated with a data transfer between internal or external systems 105, 123 on the network 110, based on a type of service ports associated with the data transfer between internal or external systems on the network 110, based on the volume and time period of the data transfer between internal or external systems on the network, or based on one of the day of week or time of day of the data transfer between internal or external systems on the network 111, forced fragmentation of information in the data transfer between internal or external systems on the network 110, and the location of executable code, commands or scripts in the data transfer between internal or external systems on the network 110. In some embodiments, the determination of the real-time integrity of the data exchange also includes determining whether a data infiltration threat or a data exfiltration threat is associated with the application 197 or the service 199.

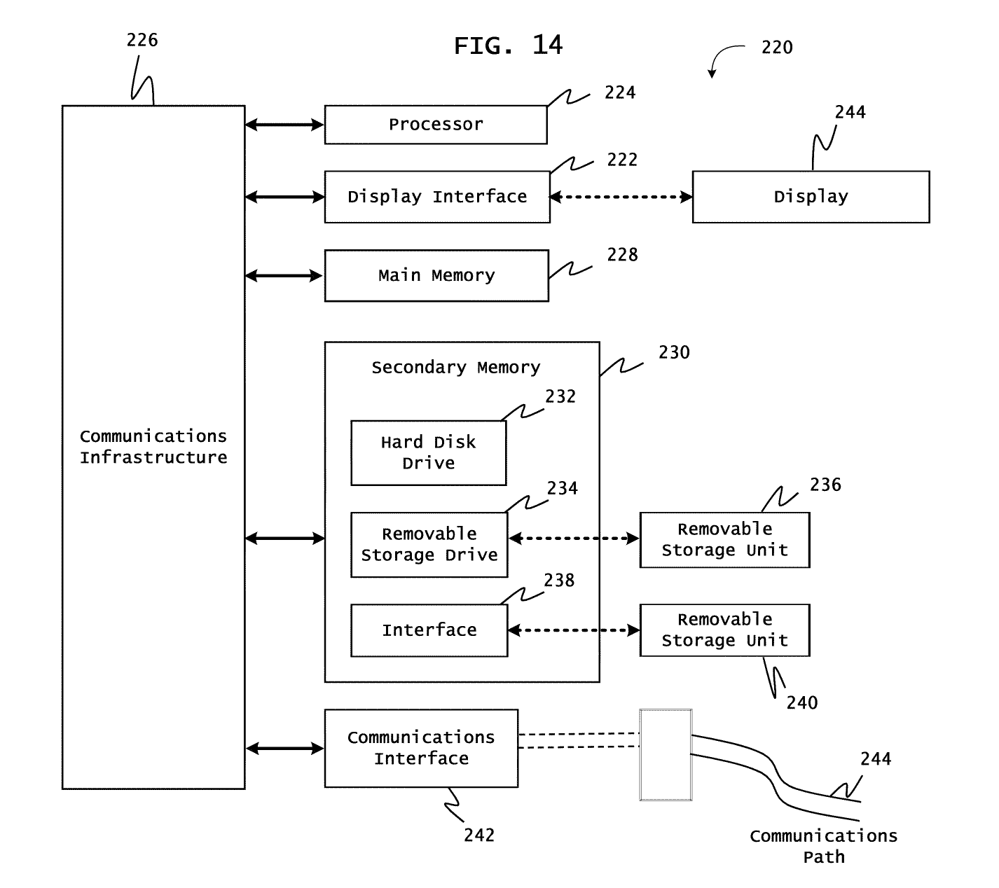

Although exemplary embodiments have been described in terms of a computing device or instrumented platform, it is contemplated that it may be implemented in software on microprocessors/general purpose computers such as the computer system 220 illustrated in FIG. 14. In various embodiments, one or more of the functions of the various components may be implemented in software that controls a computing device, such as computer system 220, which is described below with reference to FIG. 14.

Aspects of the present invention shown in FIGS. 1-14, or any part(s) or function(s) thereof, may be implemented using hardware, software modules, firmware, non-transitory computer readable media having instructions stored thereon, or a combination thereof and may be implemented in one or more computer systems or other processing systems.

FIG. 14 illustrates an example computer system 220 in which embodiments of the present invention, or portions thereof, may be implemented as computer-readable code. For example, the network systems and architectures disclosed here can be implemented in computer system 220 using hardware, software, firmware, non-transitory computer readable media having instructions stored thereon, or a combination thereof and may be implemented in one or more computer systems or other processing systems. Hardware, software, or any combination of such may embody any of the modules and components used to implement the architectures and systems disclosed herein.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor, a plurality of processors, or combinations thereof. Processor devices may have one or more processor “cores.”

Various embodiments of the invention are described in terms of this example computer system 220. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 224 may be a special purpose or a general-purpose processor device. As will be appreciated by persons skilled in the relevant art, processor device 224 may also be a single processor in a multi-core/multiprocessor system, such system operating alone, or in a cluster of computing devices operating in a cluster or server farm. Processor device 224 is connected to a communication infrastructure 224, for example, a bus, message queue, network, or multi-core message-passing scheme.

The computer system 220 also includes a main memory 228, for example, random access memory (RAM), and may also include a secondary memory 230. Secondary memory 230 may include, for example, a hard disk drive 232, removable storage drive 224. Removable storage drive 234 may comprise a floppy disk drive, a magnetic tape drive, an optical disk drive, a flash memory, or the like.

The removable storage drive 234 reads from and/or writes to a removable storage unit 236 in a well-known manner. Removable storage unit 236 may comprise a floppy disk, magnetic tape, optical disk, etc. which is read by and written to by removable storage drive 234. As will be appreciated by persons skilled in the relevant art, removable storage unit 236 includes a non-transitory computer usable storage medium having stored therein computer software and/or data.

In alternative implementations, secondary memory 230 may include other similar means for allowing computer programs or other instructions to be loaded into computer system 220. Such means may include, for example, a removable storage unit 240 and an interface 238. Examples of such means may include a program cartridge and cartridge interface (such as that found in video game devices), a removable memory chip (such as an EPROM, or PROM) and associated socket, and other removable storage units 240 and interfaces 238 which allow software and data to be transferred from the removable storage unit 236 to computer system 220.

The computer system 220 may also include a communications interface 242. Communications interface 242 allows software and data to be transferred between computer system 220 and external devices. Communications interface 242 may include a modem, a network interface (such as an Ethernet card), a communications port, a PCMCIA slot and card, or the like. Software and data transferred via communications interface 242 may be in the form of signals, which may be electronic, electromagnetic, optical, or other signals capable of being received by communications interface 242. These signals may be provided to communications interface 242 via a communications path 244. Communications path 244 carries signals and may be implemented using wire or cable, fiber optics, a phone line, a cellular phone link, an RF link or other communications channels.

The computer system 220 may also include a computer display 244 and a display interface 222. According to embodiments, the display used to display the GUIs and dashboards shown in FIGS. 10-11 and described above may be the computer display 244, and the console interface may be display interface 222.

In this document, the terms “computer program medium,” “non-transitory computer readable medium,” and “computer usable medium” are used to generally refer to media such as removable storage unit 236, removable storage unit 240, and a hard disk installed in hard disk drive 232. Signals carried over communications path 244 can also embody the logic described herein. Computer program medium and computer usable medium can also refer to memories, such as main memory 228 and secondary memory 230, which can be memory semiconductors (e.g., DRAMs, etc.). These computer program products are means for providing software to computer system 220.

Computer programs (also called computer control logic) are stored in main memory 228 and/or secondary memory 230. Computer programs may also be received via communications interface 242. Such computer programs, when executed, enable computer system 220 to implement the present invention as discussed herein. In particular, the computer programs, when executed, enable processor device 224 to implement the processes of the present invention, such as the stages in the methods illustrated by the flowcharts in FIGS. 5, 7, 12, and 13, discussed above. Accordingly, such computer programs represent controllers of the computer system 220. Where the invention is implemented using software, the software may be stored in a computer program product and loaded into computer system 220 using removable storage drive 234, interface 238, and hard disk drive 232, or communications interface 242.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

### Forensic Confidence Scores

The forensic confidence score (or forensic score) of a monitored system is the sum of several sub score calculations annotated below. All infection profiles 120 reported for a monitored system (e.g. network devices, endpoints) are processed using different computational rules. The various components of the forensic confidence score are updated throughout the monitoring process. The basic building block to construct a malware infection life cycle begins with grammar formulated by rules (expressions on packet headers and/or content, and flow semantics) to detect network events (flow events or episodes). A detected network event, in isolation, does not signify an infection event. Rather, the flow event is translated (mapped) to a dialog event that symbolizes an episode in a sequence that may eventually transform into a profile. A profile is set of episodes detected within a diagnosis window (time slice) that provides evidence of risky behaviors associated with a particular monitored system. A plurality of profiles is required for a positive identification of the nature and classification of a threat on a monitored system. A singular rule may trigger based on criteria that may be construed as a false positive. The triggering of a rule is merely an indicator of a dialog event (e.g. a binary content download, attempt to communicate with a suspect site or domain, a scan activity, etc.). Multiple dialog event and profile clusters are analyzed to calculate a forensic confidence score and risk index to identify active threats. The Attack Warning and Response Engine (AWARE) score is generated by a calculus of risk inferred from specific sub scores as described below. The term “actor” refers to a device, system, or service with an attribution of observed behaviors. The algorithm is expressed in an implementation agnostic format. The catalogs referenced may be specified as a text or XML file.

A rule may be specified to describe a named data structure (e.g. {FORENSIC SCORE}) and a named field of the named data structure (e.g. {High AWARE Score}) in expressions that include operators (e.g. set to, add to list, add, etc.). A set of constants are defined as weights represented as an integer or a fraction. The constants may include at least a {Low Score Threshold}, a {High Score Threshold}, a {High Credit}, a {Medium Credit}, a {Low Credit}, a {Repeat Pattern Count}, a {Similarity Minimum}, and a {Similarity Threshold}.

A rule may specify that if the {Profile Score} exceeds the {High Score Threshold} then (a) {FORENSIC SCORE}.{High AWARE Score} be set to {FORENSIC SCORE}.{High Credit}; (b) the profile be added to the {FORENSIC SCORE}.{High AWARE Score Profiles} list; and (c) the profile be added to the {FORENSIC SCORE}.{Forensic Profiles} list if not already added. A rule may further specify that if the {Profile Score} exceeds {Low Score Threshold} and number of dialog classes hits is greater than or equal to 2 then (a) {FORENSIC SCORE}.{High AWARE Score} be set to {FORENSIC SCORE}. {Low Credit}; (b) the profile be added to the {FORENSIC SCORE}.{High AWARE Score Profiles} list; and (c) the profile be added to the {FORENSIC SCORE}.{Forensic Profiles} list if not already added.

A rule may specify that the exploit evidence and egg download evidence be compared. If an external attacker having both evidences against it is found then (a) {FORENSIC SCORE}.{Attacker Score} be set to {FORENSIC SCORE}.{High Credit}; (b) the profile be added to the {FORENSIC SCORE}.{Attacker Score Profiles} list; and (c) the profile be added to the {FORENSIC SCORE}.{Forensic Profiles} list if not already added.

A rule may specify that an intersection be found between rule identifiers from a malware propagators catalog (of actors) and rule identifiers from the profile. If the intersection count exceeds {FORENSIC SCORE}.{Repeat Pattern Count} then (a) {FORENSIC SCORE}.{Command and Control Score} be set to {FORENSIC SCORE}.{High Credit}; (b) the profile be added to the {FORENSIC SCORE}.{Command and Control Score Profiles} list; and (c) the profile be added to the {FORENSIC SCORE}.{Forensic Profiles} list if not already added.

A rule may specify that an intersection be found between rule identifiers from a Command and Control catalog (of actors) and rule identifiers from the profile. If the intersection count exceeds 0 then (a) {FORENSIC SCORE}.{Command and Control Score} be set to {FORENSIC SCORE}.{Medium Credit}; (b) the profile be added to {FORENSIC SCORE}.{Command and Control Score Profiles} list; and (c) the profile to {FORENSIC SCORE}.{Forensic Profiles} list if not already added.

A rule may specify that an intersection be found between rule identifiers from a Spy catalog (of actors) and rule identifiers from the profile. If the intersection count exceeds 0 then (a) {FORENSIC SCORE}.{Spy Score} be set to {FORENSIC SCORE}.{Medium Credit}; (b) the profile be added to the {FORENSIC SCORE}.{Spy Score Profiles} list; and (c) the profile be added to the {FORENSIC SCORE}.{Forensic Profiles} list if not already added.

A rule may specify that an intersection be found between rule identifiers from a DNS Check-in catalog (of actors) and rule identifiers from the profile. If the intersection count exceeds 0 then (a) {FORENSIC SCORE}.{DNS Checkin Score} be set to {FORENSIC SCORE}.{Low Credit}; (b) the profile be added to the {FORENSIC SCORE}.{DNS Checkin Score Profiles} list; and (c) the profile to the {FORENSIC SCORE}.{Forensic Profiles} list if not already added.

A rule may specify that the list of rule identifier weights be retrieved from the profile and compared with the pattern library catalog by applying the similarity algorithm. The profile may be scanned and depending on the rule identifiers a pattern created dynamically. This pattern may then be compared with each of the patterns in the pattern library and a {Similarity} value calculated. If {Similarity} exceeds a {Maximum Similarity} then (a) {Maximum Similarity} be set to {Similarity}; (b) {Pattern Name} be set to {Library Pattern}.{Pattern Name}; (c) {Pattern Score} be set to {Library Pattern}.{Pattern Score}; and (d) {Category Name} be set to {Library Pattern}.{Category Name}. After all patterns from the library have been compared with the pattern from the profile, if {Maximum Similarity} exceeds {Similarity Threshold} then (a) {FORENSIC SCORE}.{Maximum Pattern Score} be set to {Pattern Score}; (b) {FORENSIC SCORE}.Detected be set to {New Pattern}.Category Name; (c) {FORENSIC SCORE}.{Detection Description} be set to a description from a category catalog based on Category Name; (d) {FORENSIC SCORE}.{Mitigation} be set to a mitigation from a category catalog based on Category Name; (e) the profile be added to the {FORENSIC SCORE}.{Maximum Pattern Score Profiles} list; (f) the profile be added to the {FORENSIC SCORE}.{Forensic Profiles} list if not already added; and (g) the detected pattern be added to the {FORENSIC SCORE}.{Detected Patterns} list.

When calculating the forensic score, a set of rules may be described to populate the {High AWARE Score}, {Attacker Score}, {Spy Score}, {Command and Control Score}, {DNS Checkin Score} and the {Maximum Pattern Score} values which may then be added to get the final {Forensic Score}. In certain exemplary embodiments, the rules may be also include additional catalog types (e.g. Repeat Scanner, RBN, Bot Space) as extensible sub scores. The {FORENSIC SCORE}.Score may be set as the sum of at least the {FORENSIC SCORE}.{High AWARE Score}, the {FORENSIC SCORE}.{Attacker Score}, the {FORENSIC SCORE}.{Repeat Scanner Score}, the {FORENSIC SCORE}.{Command and Control Score}, the {FORENSIC SCORE}.{Spy Score}, the {FORENSIC SCORE}.{RBN Score}, the {FORENSIC SCORE}.{DNS Checkin Score}, the {FORENSIC SCORE}.{Bot Space Score}, and the {FORENSIC SCORE}.{Maximum Pattern Score}.

A risk level calculation may be based on the forensic confidence score, wherein a risk index may be determined by mapping the score on a scale of 0 to 100, to a level on a scale of 0 to 5. Threat classification may be performed using a pattern match by rule class type, with a partial or strict filter. For a pattern match by rule class type, the profile may be scanned and depending on the rule identifiers and dialog events, a pattern may be created dynamically. Referring to this pattern as {Profile Rule Identifier Pattern}, this pattern may then be compared with each of the {Rule Identifier} based patterns in the pattern library and a {Similarity} value calculated. If {Similarity} exceeds {Maximum Similarity} then (a) {Maximum Similarity} be set to {Similarity}; (b) {Pattern Name} be set to {Library Pattern}.{Pattern Name}; (c) {Pattern Score} be set to {Library Pattern}.{Pattern Score}; and (d) {Category Name} be set to {Library Pattern}.{Category Name}. After all patterns from the library are compared with the pattern from the profile, if {Maximum Similarity} exceeds {Similarity Threshold} then (a) {FORENSIC SCORE}.{Maximum Pattern Score} be set to {Pattern Score}; (b) {FORENSIC SCORE}.Detected be set to {New Pattern}.{Category Name}; (c) {FORENSIC SCORE}.{Detection Description} be set to a description from category catalog based on {Category Name}; (d) {FORENSIC SCORE}.{Mitigation} be set to a mitigation from category catalog based on {Category Name}; (e) the profile be added to {FORENSIC SCORE}.{Maximum Pattern Score Profiles} list; (f) the profile be added to {FORENSIC SCORE}.{Forensic Profiles} list if not already added; and (g) the detected pattern be added to {FORENSIC SCORE}.{Detected Patterns} list.

For a pattern match by rule class type, another pattern may be created based on the {Profile Rule Identifier Pattern}. Here, the rule identifier may be replaced by the {Class Type} retrieved from the rule definition. Referring to this pattern as {Profile Class Type Pattern}, the dialog events item in the pattern may remain unchanged. This pattern may then be compared with each of the {Class Type} based patterns in the pattern library catalog and a {Similarity} value calculated. If {Similarity} exceeds {Maximum Similarity} then (a) {Maximum Similarity} be set to {Similarity}; (b) {Pattern Name} be set to {Library Pattern}.{Pattern Name}; (c) {Pattern Score} be set to {Library Pattern}.{Pattern Score}; and (d) {Category Name} be set to {Library Pattern}.{Category Name}. After all patterns from the library are compared with the pattern from the profile, if {Maximum Similarity} exceeds {Similarity Threshold} then (a) {FORENSIC SCORE}.Maximum Pattern Score be set to Pattern Score; (b) {FORENSIC SCORE}.{Detected} be set to {New Pattern}.{Category Name}; (c) {FORENSIC SCORE}.{Detection Description} be set to a description from category catalog based on {Category Name}; (d) {FORENSIC SCORE}.{Mitigation} be set to a mitigation from category catalog based on {Category Name}; (e) the profile be added to the {FORENSIC SCORE}.{Maximum Pattern Score Profiles} list; (f) the profile be added to the {FORENSIC SCORE}.{Forensic Profiles} list if not already added; and (g) the detected pattern be added to the {FORENSIC SCORE}.{Detected Patterns} list.

A partial filter may be specified to perform the following checks on the dialog class events of the {Profile Class Type Pattern}. If the {Class Type} based pattern from the patterns catalog (referring to this as {Reference} pattern) and {Profile Class Type Pattern} both have three or more dialog event classes hit, then at least three dialog event classes from the {Profile Class Type Pattern} should be present in the {Reference} pattern. If the {Profile Class Type Pattern} has less than three dialog event classes hit, then the {Reference} pattern must have an exact match (i.e. same number and type of dialog event classes hit). An example is illustrated in Table 1 below.

TABLE 1
Partial Filter Profile Class Type Patterns

| | Reference | Profile Class Type | Use Similarity |
|---|---|---|---|
| | Pattern | Pattern | Algorithm |
| 1 | E2, E5, E6, E7 | E2, E5, E6, E7 | Yes |
| 2 | E2, E5, E6, E8 | E2, E5, E6, E7 | Yes |
| 3 | E2, E5, E6 | E2, E5, E6, E7 | Yes |
| 4 | E2, E5 | E2, E5 | Yes |
| 5 | E2 | E2 | Yes |
| 6 | E2, E5, E4, E8 | E2, E5, E6, E7 | No |
| 7 | E2, E5 | E2, E3 | No |
| 8 | E2 | E5 | No |
| 9 | E2, E5, E4, E8 | E5 | No |

A strict filter may be specified to perform the following checks on the dialog event classes and the rule {Class Type} items of the {Profile Class Type Pattern}. The {Reference} pattern must have an exact match with the {Profile Class Type Pattern} (i.e. same number and type of dialog event classes hit). An example is illustrated in Table 2 below.

TABLE 2
Strict Filter Dialog Event Classes

| | Reference | Profile Class Type | Use Similarity |
|---|---|---|---|
| | Pattern | Pattern | Algorithm |
| 1 | E2, E5, E6, E7 | E2, E5, E6, E7 | Yes |
| 2 | E2, E5, E6, E8 | E2, E5, E6, E7 | No |
| 3 | E2, E5, E6 | E2, E5, E6, E7 | No |
| 4 | E2, E5 | E2, E5 | Yes |
| 5 | E2 | E2 | Yes |
| 6 | E2, E5, E4, E8 | E2, E5, E6, E7 | No |
| 7 | E2, E5 | E2, E3 | No |
| 8 | E2 | E5 | No |
| 9 | E2, E5, E4, E8 | E5 | No |

In addition, the {Reference} pattern must have all the rule {Class Type} hits by the {Profile Class Type Pattern}. The {Reference} pattern may have greater than or equal to but not less than the number of items as compared to the {Profile Class Type Pattern}. An example, considering that the dialog class condition is satisfied, is illustrated in Table 3 below.

TABLE 3
Strict Filter Rule Class Types

| | Reference | Profile Class Type | Use Similarity |
|---|---|---|---|
| | Pattern | Pattern | Algorithm |
| 1 | successful-user | successful-user | Yes |
| | unsuccessful- | unsuccessful-user | |
| | user | successful-admin | |
| | successful- | Trojan-activity | |
| | admin | E2, E5 | |
| | Trojan-activity | | |
| | E2, E5 | | |
| 2 | successful-user | successful-user | Yes |
| | unsuccessful- | unsuccessful-user | |
| | user | Trojan-activity | |
| | successful- | E2, E5 | |
| | admin | | |
| | Trojan-activity | | |
| | misc-activity | | |
| | E2, E5 | | |
| 3 | successful-user | successful-user | Yes |
| | unsuccessful- | Trojan-activity | |
| | user | Trojan-activity | |
| | Trojan-activity | E2, E5 | |
| | misc-activity | | |
| | E2, E5 | | |
| 4 | successful-user | successful-user | No |
| | unsuccessful- | unsuccessful-user | |
| | user | successful-admin | |
| | successful- | Trojan-activity | |
| | admin | E2, E5 | |
| | misc-activity | | |
| | E2, E5 | | |
| 5 | successful-user | successful-user | No |
| | unsuccessful- | unsuccessful-user | |
| | user | successful-admin | |
| | successful- | Trojan-activity | |
| | admin | E2, E5 | |
| | E2, E5 | | |

To define the metrics that identify the true content type of a block in the packet payload as text (ASCII, Unicode) or binary (obfuscated, encoded, encrypted) a large set of packet captures (PCAP files), DNS domains to simulate a domain generation algorithm (DGA), text and binary content files are examined by a computer program. The file contents are parsed to generate a tabulation of content block metrics as illustrated in FIG. 6 using mathematical functions. The range of metrics associated with the content types are identified based on the tabulation and included in the threat grammar as low and high thresholds.

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Although the invention is illustrated and described herein with reference to specific embodiments, the invention is not intended to be limited to the details shown. Rather, various modifications may be made in the details within the scope and range equivalents of the claims and without departing from the invention.

```
APPENDIX
<code-grammar>
  <!-- Callback Obfuscation & Data Exchange (CODE) Threat
Grammar -->
    <global>
      <!-- Unsolicited POST request -->
      <unsolicited-post-exfiltration value=“128”/>
      <!-- Restrict specific content types in GET (reserved
for future use) -->
      <suspect-get-content value=“”/>
      <!-- Restrict content in GET (reserved for future use)
-->
      <get-content value=“alert”/>
      <!-- Unwarranted fragmentation of HTTP request header
and content sections -->
      <fragmented-http-request value=“alert”/>
      <!-- Comma separated list of HTTP request headers
(reserved for future use) -->
      <http-request-sequence value=“”/>
      <!-- Comma separated list of HTTP response headers
(reserved for future use) -->
      <http-response-sequence value=“”/>
      <!-- Total RX/TX bytes from client to server in a
standard service transaction -->
      <service-data-exchange>
        <!-- threshold=0 bytes (no limit) -->
        <service>
          <!-- FTP -->
          <port value=“21”/>”
          <threshold-rx value=“0”/>
          <threshold-tx value=“10240”/>
        </service>
        <service>
          <!-- SSH -->
          <port value=“22”/>”
          <threshold-rx value=“0”/>
          <threshold-tx value=“0”/>
        </service>
        <service>
          <!-- Telnet -->
          <port value=“23”/>”
          <threshold-rx value=“0”/>
          <threshold-tx value=“0”/>
        </service>
        <service>
          <!-- SMTP -->
          <port value=“25”/>”
          <threshold-rx value=“0”/>
          <threshold-tx value=“0”/>
        </service>
        <service>
          <!-- NTP -->
          <port value=“123”/>”
          <threshold-rx value=“0”/>
          <threshold-tx value=“0”/>
        </service>
        <service>
          <!-- DNS -->
          <port value=“53”/>”
          <threshold-rx value=“10000”/> <!-- 10KB -->
          <threshold-tx value=“0”/>
        </service>
      </service-data-exchange>
      <!-- Suggest specific HTTP headers to inspect for
restricted content -->
      <!-- (reserved for future use) -->
      <http-headers-inspect value=“cookie”/>
      <!-- Restrict content in HTTP headers (all, unless
specific headers are suggested) (reserved for future use) --
>
      <restrict-content value=“”/>
      <!-- Restrict unwarranted fragmantation of transport
payload -->
      <fragmented-transport-header value=“permit”/>
<code-grammar>
  <!-- Callback Obfuscation & Data Exchange (CODE) Threat
Grammar -->
    <global>
      <!-- Unsolicited POST request -->
      <unsolicited-post-exfiltration value=“128”/>
      <!-- Restrict specific content types in GET (reserved
for future use) -->
      <suspect-get-content value=“”/>
      <!-- Restrict content in GET (reserved for future use)
-->
      <get-content value=“alert”/>
      <!-- Unwarranted fragmentation of HTTP request header
and content sections -->
      <fragmented-http-request value-“alert”/>
      <!-- Comma separated list of HTTP request headers
(reserved for future use) -->
      <http-request-sequence value=“”>
      <!-- Comma separated list of HTTP response headers
(reserved for future use) -->
      <http-response-sequence value=“”/>
      <!-- Total RX/TX bytes from client to server in a
standard service transaction -->
      <service-data-exchange>
        <!-- threshold=0 bytes (no limit) -->
        <service>
          <!-- FTP -->
          <port value=“21”/>”
          <threshold-rx value =“0”/>
          <threshold-tx value=“10240”/>
        </service>
        <service>
          <!-- SSH -->
          <port value=“22”/>”
          <threshold-rx value=“0”/>
          <threshold-tx value=“0”/>
        </service>
        <service>
          <!-- Telnet -->
          <port value=“23”/>”
          <threshold-rx value=“0”/>
          <threshold-tx value=“0”/>
        </service>
        <service>
          <!-- SMTP -->
          <port value=“25”/>”
          <threshold-rx value=“0”/>
          <threshold-tx value=“0”/>
        </service>
        <service>
          <!-- NTP -->
          <port value=“123”/>”
          <threshold-rx value=“0”/>
          <threshold-tx value=“0”/>
        </service>
        <service>
          <!-- DNS -->
          <port value=“53”/>”
          <threshold-rx value=“10000”/> <!-- 10KB -->
          <threshold-tx value=“0”/>
        </service>
      </service-data-exchange>
      <!-- Suggest specific HTTP headers to inspect for
restricted content -->
      <!-- (reserved for future use) -->
      <http-headers-inspect value=“cookie”/>
      <!-- Restrict content in HTTP headers (all, unless
specific headers are suggested) (reserved for future use) --
>
      <restrict-content value=“”/>
      <!-- Restrict unwarranted fragmantation of transport
payload -->
      <fragmented-transport-header value=“permit”/>
      <!-- Data haul detection (reserved for future use) -->
      <data-haul>
        <duration value=“7”/> <!-- days -->
        <size value=“500000000”/> <!-- 500MB -->
        <!-- Common Zone Enumeration -->
        <!-- APPLICATION-SERVERS, SCANNERS, POS-DEVICES,
WORKSTATIONS, PRINTERS, -->
        <!-- NETWORK-DEVICES, REMOTE-TERMINALS,
PARTNERS-NETWORK, BYOD, -->
        <!-- MOBILE DEVICES, CRITICAL-INFRASTRUCTURE,
VOIP-SERVERS, CLOUD-SERVERS, NTP-SERVERS -->
        <zone value=“WORKSTATIONS, CRITICAL-
        INFRASTRUCTURE”/>
      </data-haul>
    </global>
  <rules>
    <content-type value=“aware/response”>
      <description value=“Detect obfuscation in HTTP
response”/>
          <offset value=“2”/>
          <length value=“128”/>
          <recurrence value=“”/>
          <interval value=“”/>
      <day-of-week value=“”/>
      <time-of-day value=“”/>
      <initial-request-range>
          <min value=“0”/>
          <max value=“0”/>
        </initial-request-range>
          <ephemeral-port-range value=“”/>
        <metrics>
          <entropy value=“GE 4.58”/>
          <mean value=“GT 95”/>
          <chi-square value=“”/>
          <monte-carlo-pi value=“”/>
          <or>
              <entropy value=“”/>
              <mean value=“”/>
              <chi-square value=“”/>
              <monte-carlo-pi value=“”/>
          </or>
        </metrics>
    </content-type>
    <content-type value=“aware/get-name-value”>
      <description value=“Detect obfuscation of values in a
GET request”/>
      <offset value=“”/>
      <length value=“”/>
      <recurrence value=“”/>
      <interval value=“”/>
      <day-of-week value=“”/>
      <time-of-day value=“”/>
      <initial-request-range>
          <min value=“32”/>
          <max value =“512”/>
      </initial-request-range>
      <ephemeral-port-range value=“”/>
      <metrics>
          <entropy value=“GE 4.58”/>
          <mean value=“GT 95”/>
          <chi-square value=“”/>
          <monte-carlo-pi value=“”/>
          <or>
              <entropy value=“”/>
              <mean value=“”/>
              <chi-square value=“”/>
              <monte-carlo-pi value=“”/>
          </or>
      </metrics>
    </content-type>
    <content-type value=“aware/post-name-value”>
      <description value=“Detect obfuscation of values in a
POST request”/>
      <offset value=“”/>
      <length value=“”/>
      <recurrence value=“”/>
      <interval value=“”/>
      <day-of-week value=“”/>
      <time-of-day value=“”/>
```

What is claimed is:

1. A method of determining real-time operational integrity of an application or service operating on a computing device, the method comprising:
inspecting network traffic sent or received by the application or the service operating on the computing device;
determining in real-time, by a network analyzer of an endpoint trust agent on the computing device, signaling integrity of the application or the service based on the inspecting of the network traffic to assess trustworthiness of the signaling; and
determining, by the network analyzer, that the application or the service is malicious based on the determined trustworthiness of the signaling.

2. The method of claim 1, further comprising:
determining if a threat is posed by the application or the service based on the trustworthiness of the signaling.

3. The method of claim 1, wherein the signaling integrity is determined based on a plurality of content entropy discrepancies in data blocks associated with messaging between internal or external systems on the network.

4. The method of claim 1, wherein the signaling integrity is determined based on a content type mismatch in data blocks associated with messaging between internal or external systems on the network.

5. The method of claim 1, wherein the signaling integrity is determined based on a type of service ports associated with messaging between internal or external systems on the network.

6. The method of claim 1, wherein the signaling integrity is determined based on the frequency of messaging attempts between internal or external systems on the network.

7. The method of claim 1, wherein the inspecting the network traffic includes inspecting a payload of a data packet.

8. The method of claim 1, wherein the determining of the real-time signaling integrity also includes determining whether a malicious callback threat is associated with the application or the service.

9. The method of claim 1, further comprising:
generating, by a runtime dashboard, a real-time forensic confidence score as a measure of real-time threat relevance of the application or the service; and
displaying the real-time forensic confidence score.

10. The method of claim 1, further comprising:
displaying, in a runtime dashboard, real-time status indications for operational integrity of the application or service operating on the computing device.

11. The method of claim 10, wherein the runtime dashboard is an application integrity dashboard for reputation scoring that displays evidence of an associated application launch sequence for breach detection and breach analysis.

12. The method of claim 10, wherein the runtime dashboard is a network activity dashboard for reputation scoring that displays a real-time forensic confidence score and evidence of the application or service associated with the activity on the computing device.

13. The method of claim 10, wherein the runtime dashboard is a resource utilization dashboard for reputation scoring that displays an application program interface call stack to identify operating system resources leveraged in an attack.

14. The method of claim 10, wherein the runtime dashboard is a global view dashboard for reputation scoring that displays a real-time forensic confidence score and a malicious callback associated with a subject.

15. The method of claim 10, wherein the runtime dashboard is a global view dashboard for reputation scoring that displays a real-time forensic confidence score and a malicious data infiltration associated with a subject.

16. The method of claim 10, wherein the runtime dashboard is a global view dashboard for reputation scoring that displays a real-time forensic confidence score and a malicious data exfiltration associated with a subject.

17. A method of determining real-time operational integrity of an application or service operating on a computing device, the method comprising:
inspecting network traffic sent or received by the application or the service operating on the computing device;
determining in real-time, by a network analyzer of an endpoint trust agent on the computing device, integrity of a data exchange of the application or the service based on the inspecting of the network traffic to assess trustworthiness of the data exchange; and
determining, by the network analyzer, that the application or the service is malicious based on the determined trustworthiness of the data exchange.

18. The method of claim 17, further comprising:
determining if a threat is posed by the application or the service based on the trustworthiness of the data exchange.

19. The method of claim 17, wherein the integrity of the data exchange is determined based on a plurality of content entropy discrepancies in data blocks associated with the data transfer between internal or external systems on the network.

20. The method of claim 17, wherein the integrity of the data exchange is determined based on a content type mismatch in data blocks associated with a data transfer between internal or external systems on the network.

21. The method of claim 17, wherein the integrity of the data exchange is determined based on a type of service ports associated with the data transfer between internal or external systems on the network.

22. The method of claim 17, wherein the integrity of the data exchange is determined based on the volume and time period of the data transfer between internal or external systems on the network.

23. The method of claim 17, wherein the integrity of the data exchange is determined based on one of:
the day of week or time of day of the data transfer between internal or external systems on the network,
forced fragmentation of information in the data transfer between internal or external systems on the network, and
the location of executable code, commands or scripts in the data transfer between internal or external systems on the network.

24. The method of claim 17, wherein the determining of the real-time integrity of the data exchange also includes determining whether a data infiltration threat or a data exfiltration threat is associated with the application or the service.

25. The method of claim 17, further comprising:
displaying, in a runtime dashboard, real-time status indications for operational integrity of the application or service operating on the computing device.

26. The method of claim 25, wherein the runtime dashboard is an application integrity dashboard for reputation scoring that displays evidence of an associated application launch sequence for breach detection and breach analysis.

27. The method of claim 25, wherein the runtime dashboard is a network activity dashboard for reputation scoring that displays a real-time forensic confidence score and evidence of the application or service associated with the activity on the computing device.

28. The method of claim 25, wherein the runtime dashboard is a resource utilization dashboard for reputation scoring that displays an application program interface call stack to identify operating system resources leveraged in an attack.

29. The method of claim 25, wherein the runtime dashboard is a global view dashboard for reputation scoring that displays a real-time forensic confidence score and a malicious callback associated with a subject.

30. The method of claim 25, wherein the runtime dashboard is a global view dashboard for reputation scoring that displays a real-time forensic confidence score and malicious data infiltration associated with a subject or displays a real-time forensic confidence score and malicious data exfiltration associated with a subject.
